(19) United States
(12) Patent Application Publication
(10) Pub. No.: US 2003/0064208 A1
(43) Pub. Date: Apr. 3, 2003

(54) Inkjet recording sheet

(75) Inventors: Hisao Yamada, Shizuoka-ken (JP); Kazuyuki Koike, Shizuoka-ken (JP); Masanobu Takashima, Shizuoka-ken (JP); Kozo Nagata, Shizuoka-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/151,187

(22) Filed: May 21, 2002

(30) Foreign Application Priority Data
May 22, 2001 (JP) 2001-152237
Apr. 10, 2002 (JP) 2002-108131

(51) Int. Cl. B32B 3/00

(52) U.S. Cl. 428/195

(57) ABSTRACT

An inkjet recording sheet comprising a support, on the support, a colorant-receiving layer including a phenolic compound and at least one organic mordant selected from the group consisting of a polyallylamines and their derivatives, a polyvinylamine and their derivatives.

### BACKGROUND OF THE INVENTION

1. Field of the Invention

The present invention relates to a recording material supplied for inkjet recording using liquid inks, such as water-color inks (inks using a dye or a pigment as the colorant) or oil inks, and solid inks, which are solid at normal temperature and are melted and liquefied when applied for printing, and, specifically, to an inkjet recording sheet which has excellent ink-accepting performance, is free from bleeding over time and has high light fastness and ozone-resistance.

2. Description of the Related Art

With the rapid development of industries of information technologies in recent years, various information processing systems, recording methods and recording devices suitable for these information processing systems have been developed and put to practical use.

Among these recording methods, an inkjet recording method has come to be widely used for so-called “home uses” as well as office uses because it has the advantages of enabling recording to various recording materials, being provided with relatively inexpensive and compact hardware (devices) and having excellent quietness.

It has become possible to obtain so-called “photograph-like” high image quality records along with the recent development of inkjet printers having high resolution. Along with the progress of the hardware, various recording sheets for use in inkjet recording have been developed.

General characteristics required when this recording sheet is used is inkjet recording are: (1) a rapid drying ability (high ink absorbing rate), (2) proper and uniform diameter of dots (free from bleeding), (3) a good granularity, (4) high dot circularity, (5) high color density, (6) high chromaticity (no subdued tones), (7) a high water resistance, light fastness and ozone resistance in a printed section, (8) a high whiteness of the recording sheet, (9) a good preservability of the recording sheet (no yellowing during long-term storage), (10) less deformability and good dimensional stability (sufficiently small curling), (11) a high ability to be run in hardware and the like.

Further, in the use of photo-glossy paper used for the purpose of obtaining so-called “photograph-like” high-quality recorded material, glossiness, surface smoothness, printing paper feeling similar to that of a silver salt photograph and the like are required in addition to the above various characteristics.

In recent years, inkjet recording sheets with a colorant-receiving layer having a porous structure have been developed and put to practical use with the intention to improve the various aforementioned characteristics. This inkjet recording sheet has high ink-receiving capability (quick drying characteristics) and high glossiness since it has the porous structure.

For instance, in Japanese Patent Application Laid-Open (JP-A) Nos. 10-119423 and 10-217601, inkjet recording sheets in which a colorant-receiving layer containing fine inorganic pigment particles and a water-soluble resin and having a high porosity is formed on a support are proposed.

Due to their structure, these recording sheets, particularly these inkjet recording sheets, which are provided with a colorant-receiving layer having a porous structure and using silica as an inorganic pigment fine particle, have high ink absorbancy and ink receiving capability high enough to be able to form a having high resolution image and can exhibit high glossiness.

However, trace quantities of gases in the air, particularly ozone, cause a recorded image to fade over time. The aforementioned recording material comprising a colorant-receiving layer having a porous structure has many apertures and therefore an image recorded thereon is easily faded by the ozone gas in the air. For this, a resistance to the ozone in the air (ozone resistance) is characteristic an extremely important for recording material provided with a colorant-receiving layer having a high porous structure.

In order to prevent the aforementioned fading caused by ozone, inkjet recording materials containing a sulfinic acid compound, a thiosulfonic acid compound and a thiosulfinic acid compound are proposed in JP-A No. 2001-260519. Also, an inkjet recording material containing a thioether compound having a hydrophilic group is proposed in EP 1,138,509. All of these compounds have an effect on ozone resistance. However, there is a problem that this effect does not last long and therefore these compounds can impart only insufficient ozone resistance.

An inkjet recording sheet containing a phenol derivative as a dye image fading preventive agent is disclosed in Japanese Patent Application Publication (JP-B) No. 62-26319 with the intention of improving the image preserving ability. However, although the recording sheet containing the phenol derivative is improved in light fastness, it has the problem that bleeding over time can not be sufficiently suppressed.

Techniques in which a salicylic acid type compound is contained as a preserving ability improving agent and a combination of a vapor-phase method silica and a cationic compound is used, are proposed in JP-A No. 2001-191639. As the cationic compound, a diallylamine hydrochloride/sulfur dioxide copolymer and basic poly aluminum hydroxide are described in Examples. However, there is a problem that the effects obtained by improving the resistances (light fastness and ozone resistance) of these compounds are unsatisfactory.

Also, an inkjet recording sheet containing salts of a hydroxy-substituted aromatic group, salts of a carbonic group and salts of a sulfonic group is proposed in JP-A No. 11-165461. These compounds are added to suppress the hazing of an image receiving layer of the inkjet recording sheet, but the disclosure does not refer to the improvements in resistances (light fastness and ozone resistance). Also, there is no description concerning a cationic polymer as a mordant for mordanting dyes or a pigment capable of forming a porous layer and there is a problem that only insufficient resistance to bleeding over time and ink absorbancy can be provided.

As mentioned above, an inkjet recording sheet has not yet been provided, which is comprises a colorant-receiving layer having good ink absorbancy, is able to form of an image having high resolution, has an ink receiving capability such that the formed image has superior light fastness, resistance to bleeding over time and glossiness and at the same time, possesses good preserving characteristics, particularly, ozone resistance for a sufficiently long period of time.

### SUMMARY OF THE INVENTION

Objects of the present invention are to solve the aforementioned various problems and to provide an inkjet recording sheet which has good ink-absorbancy, is free from bleeding over time and is also improved in, particularly, ozone resistance and light fastness. The invention is thus intended to attain the above objects.

The invention is based on findings that the above objects can be attained when using, particularly a combination of a phenolic compound and a polyallylamine, polyvinylamine or their derivatives thereof as an organic mordant.

Means for solving the aforementioned problems are as follows.

A first aspect of the inkjet recording sheet of the invention is an inkjet recording sheet comprising a support, and on the support, a colorant-receiving layer including: a phenolic compound; and at least one organic mordant selected from the group consisting of polyallylamine and derivatives thereof, and polyvinylamine and derivatives thereof.

A second aspect of the inkjet recording sheet of the invention is the inkjet recording sheet of the first aspect, wherein the phenolic compound comprises phenolic hydroxy groups and further comprises at least one substituent group selected from the group consisting of carboxyl groups, sulfo groups and salts thereof.

A third aspect of the inkjet recording sheet of the invention is the inkjet recording sheet of the first claim, wherein the colorant-receiving layer comprises from 0.01 g/m² to 5 g/m² of the phenolic compound.

A fourth aspect of the inkjet recording sheet of the invention is the inkjet recording sheet of the first aspect, wherein a weight average molecular weight of the organic mordant is from 500 to 100,000.

A fifth aspect of the inkjet recording sheet of the invention is the inkjet recording sheet of the first aspect, wherein the colorant-receiving layer further comprises fine particles and a water-soluble resin.

A sixth aspect of the inkjet recording sheet of the invention is the inkjet recording sheet of the fifth aspect, wherein the fine particles comprise at least one of silica fine particles, colloidal silica, alumina fine particles and pseudo-boehmite.

A seventh aspect of the inkjet recording sheet of the invention is the inkjet recording sheet of the fifth aspect, wherein the fine particles comprise at least 50 mass % relative to a total mass of solid components of the colorant-receiving layer.

An eighth aspect of the inkjet recording sheet of the invention is the inkjet recording sheet of the fifth aspect, wherein the water-soluble resin comprises at least one water-soluble resin selected from a group consisting of polyvinyl alcohols and derivatives thereof, cellulose resins, resins having an ether bond, resins having a carbamoyl group and resins having a carboxyl group.

A ninth aspect of the inkjet recording sheet of the invention is the inkjet recording sheet of the fifth aspect, wherein the water-soluble resin comprises from 9 to 40 mass % relative to a total mass of solid components of the colorant-receiving layer.

A tenth aspect of the inkjet recording sheet of the invention is the inkjet recording sheet of the fifth aspect, wherein the fine particles in the colorant-receiving layer comprise a mass (x), the water-soluble resin in the colorant-receiving layer comprises a mass (y), and a mass ratio thereof (x/y) is from 1.5 to 10.

An eleventh aspect of the inkjet recording sheet of the invention is the inkjet recording sheet of the fifth aspect, wherein the colorant-receiving layer further comprises a crosslinking agent, which can crosslink the water-soluble resin.

A twelfth aspect of the inkjet recording sheet of the invention is the inkjet recording sheet of the eleventh aspect, wherein the crosslinking agent comprises a crosslinking agent selected from a group consisting of boron compounds, aldehyde-based compounds, ketone-based compounds, active halogen compounds, active vinyl compounds, N-methylol compounds, melamine compounds, epoxy compounds, isocyanate-based compounds, aziridine-based compounds, carbodiimide-based compounds, ethylenimino-based compounds, halogenated carboxyaldehyde-based compounds, dioxane-based compounds, compounds that include a metal, polyamine compounds, hydrazide compounds, low-molecular weight compounds that include at least two oxazoline groups, polymers that include at least two oxazoline groups, multivalent acid anhydrides, acid chlorides, bissulfonate compounds and active ether compounds.

A thirteenth aspect of the inkjet recording sheet of the invention is the inkjet recording sheet of the eleventh aspect, wherein an amount of the crosslinking agent used comprises from 1 to 50 mass % of an amount of the water-soluble resin used.

A fourteenth aspect of the inkjet recording sheet of the invention is the inkjet recording sheet of the first aspect, wherein the colorant-receiving layer further comprises a fastness improver.

A fifteenth aspect of the inkjet recording sheet of the invention is the inkjet recording sheet of the first aspect, wherein the colorant-receiving layer further comprises a surfactant and a high boiling-point organic solvent.

A sixteenth aspect of the inkjet recording sheet of the invention is the inkjet recording sheet of the first aspect, wherein a pH on a surface of the colorant-receiving layer is from 3 to 8.

A seventeenth aspect of the inkjet recording sheet of the invention is the inkjet recording sheet of the first aspect, wherein a thickness of the colorant-receiving layer is from 10 to 50 μm.

An eighteenth aspect of the inkjet recording sheet of the invention is the inkjet recording sheet of the first aspect, wherein the colorant-receiving layer further comprises pores which have a median diameter of from 0.005 to 0.030 μm.

A nineteenth aspect of the inkjet recording sheet of the invention is the inkjet recording sheet of the first aspect, wherein the support is transparent, and a haze value of the colorant-receiving layer formed thereon is no more than 30%.

A twentieth aspect of the inkjet recording sheet of the invention is the inkjet recording sheet of the first aspect, wherein the colorant-receiving layer comprises a layer formed by a process including the steps of: preparing a coating liquid containing at least fine particles and a water-soluble resin; preparing a basic solution having a pH value of at least 8; adding a crosslinking agent to at least one of the coating liquid and the basic solution; applying the coating liquid to form a coated layer; drying the coated layer; crosslinking and curing the coated layer by adding the basic solution to the coated layer at a time that is at least one of (1) simultaneous with the step of applying the coating liquid to form the coated layer, and (2) before the coated layer exhibits a decreasing rate of drying during the step of drying the coated layer.

### DESCRIPTION OF THE PREFERRED EMBODIMENTS

In an inkjet recording sheet according to the present invention, a colorant-receiving layer containing a phenolic compound and an organic mordant selected from a polyallylamine, polyvinylamine and their derivatives is disposed on a support.

The inkjet recording sheet of the invention will be hereinafter explained in detail.

The inkjet recording sheet of the invention has a structure comprising a colorant-receiving layer is formed on a support. The colorant-receiving layer comprises a phenolic compound and at least one organic mordant selected from the group consisting of a polyallylamine, derivatives thereof, and a polyvinylamine and derivatives thereof. Preferably, the colorant layer further comprises fine particles and a water-soluble resin and may comprise other additives according to the need.

(Organic Mordant)

The colorant-receiving layer according to the invention contains at least one organic mordant selected from the group consisting of a polyallylamine and derivatives thereof, and polyvinylamine and derivatives thereof. Each of these organic mordants may be contained as a copolymer, which is obtained by copolymerizing the organic mordant with another copolymerizable monomer. The polyallylamine in the invention represents those prepared by polymerizing monoallylamines (including salts thereof).

Among organic mordants, compounds having a weight average molecular weight of from 500 to 100000 are desirable to prevent bleeding over time and improve ink absorbancy of the colorant-receiving layer.

As the polyallylamine and derivatives thereof, various known allylamine polymers and their derivatives may be used. Examples of these derivatives include salts of a polyallylamines and acids (examples of the acids include inorganic acids such as hydrochloric acid, sulfuric acid, phosphoric acid and nitric acid, organic acids such as methanesulfonic acid, toluenesulfonic acid, acetic acid, propionic acid, cinnamic acid and (meth)acrylic acid or combinations of these acids and those in which only a part of allylamine is converted into a salt), derivatives of a polyallylamine obtained by a high molecular reaction (for example, polymers and the like, which include repeated structural units represented by the following formulae (1) to (5)), and copolymers of a polyallylamine and other copolymerizable monomers (specific examples of the monomer include (meth)acrylates, styrenes, (meth)acrylamides, actylonitrile and vinylesters).

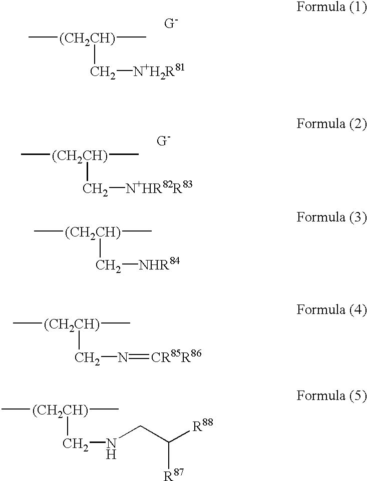

wherein R⁸¹ to R⁸⁴ respectively represent an organic group which may have a substituent; R⁸⁵ and R⁸⁶ respectively represent an organic group, which may have a substituent (the same meanings as R⁸¹ to R⁸⁴), or a hydrogen atom; R⁸⁷ represents a hydrogen atom or a methyl group; R⁸⁸ represents —COOR⁸⁹, —CN or —CONR⁹⁰R⁹¹, where R⁸⁹ to R⁹¹ respectively represent a hydrogen atom, an aliphatic group or an aromatic group; and G⁻ represents a counter anion.

The organic groups shown above denotes groups containing hydrocarbon portions and/or hydrogen halide portions and may include, besides these portions, atoms such as hydrogen, carbon, nitrogen, oxygen, sulfur, phosphorous, silicon, boron and a halogen and/or functional groups consisting of combinations of these atoms. Examples of these groups include (substituted) alkyl groups, (substituted) aralkyl groups, (substituted) aryl groups, (substituted) acryl groups, (substituted) sulfonyl groups and heterocycles.

Specific examples of the organic group represented by R⁸¹ to R⁸⁴ include alkyl groups (e.g., methyl, ethyl, n-propyl, i-propyl, n-butyl, i-butyl, sec-butyl, t-butyl, n-hexyl, cyclohexyl, n-octyl, 2-ethylhexyl, n-decyl, n-dodecyl, octadecyl, 1,3-butadienyl and 1,3-pentadienyl); aralkyl groups (e.g., benzyl, phenylethyl, vinylbenzyl, 1-phenylvinyl and 2-phenylvinyl); and aryl groups (e.g., phenyl, naphthyl, tolyl and vinylphenyl).

Moreover, examples of the organic group having a substituent include a fluoroethyl group, trifluoroethyl group, methoxyethyl group, phenoxyethyl group, hydroxyphenylmethyl group, chlorophenyl group, dichlorophenyl group, trichlorophenyl group, bromophenyl group, iodophenyl group, fluorophenyl group, hydroxyphenyl group, methoxyphenyl group, hydroxyphenyl group, acetoxyphenyl group and cyanophenyl group.

Also, examples of the organic group having a hydroxyl group are shown below.

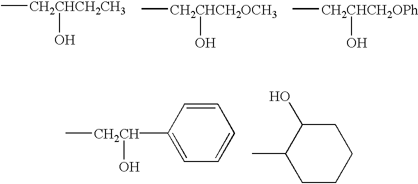

Also, organic groups shown below are given as examples.

—CR¹⁰¹R¹⁰²—COOR¹⁰³

The above R¹⁰¹ to R¹⁰³ respectively represent a hydrogen atom, an aliphatic group or an aromatic group. A methyl group, ethyl group, butyl group, benzyl group and phenyl group are given as examples of R¹⁰¹ to R¹⁰³.

—CO—R¹⁰⁴—COOH

The above R¹⁰⁴ represents a divalent connecting group and examples of this group include —CH₂CH₂—, —CH₂CH₂CH₂—, —CH═CH— and the following groups.

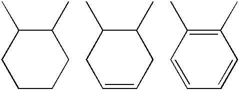

—COR¹⁰⁵, —COOR¹⁰⁶, —CONHR¹⁰⁷, —CSNHR¹⁰⁸, —SO₂R¹⁰⁹ and —P(═O)(OR¹¹⁰)₂

The above R¹⁰⁵ to R¹¹⁰ respectively represent a hydrogen atom, an aliphatic group or an aromatic group. Examples of these groups include a methyl group, ethyl group, propyl group, butyl group, octadecyl group, benzyl group, phenyl group and —CH═CH—Ph.

Also, R⁸⁷ represents a hydrogen atom or a methyl group, R88 represents —COOR¹¹¹, —CN, or —CONR¹¹²R¹¹³ and R¹¹¹ to R¹¹³ respectively represent a hydrogen atom, an aliphatic group or an aromatic group.

Specific examples of R¹¹¹ to R¹¹³ include a hydrogen atom, methyl group, ethyl group, n-propyl group, i-propyl group, n-butyl group, i-butyl group, sec-butyl group, t-butyl group, n-hexyl group, cyclohexyl group, n-octyl group, 2-ethylhexyl group, n-decyl group, n-dodecyl group, octadecyl group, allyl group, benzyl group, phenyl group, naphthyl group, biphenyl group, 1,1,1-trifluoroethyl group and 2-hydroxy-3-chloropropyl group.

Specific examples of G⁻ include halogen ions (Cl⁻, Br⁻ and I⁻), sulfonic acid ions, alkylsulfonic acid ions, arylsulfonic acid ions, alkylcarboxylic acid ions and arylcarboxylic acid ions.

There is no particular limitation to structures of these polyallylamine derivatives. Although the obtained polymer is preferably water-soluble or soluble in an organic solvent miscible with water, it may be also used in the form of a water-dispersible latex particle.

Specific examples of the polyallylamine and derivatives thereof include compounds described in each of JP-B Nos. 62-31722, 2-14364, 63-43402, 63-43403, 63-45721, 63-29881, 1-26362, 2-56365, 2-57084, 4-41686, 6-2780, 6-45649, 6-15592, 4-68622, JP Nos. 3199227, 3008369, JP-A Nos. 10-330427, 11-21321, 2000-281728, 2001-106736, 62-256801, 7-173286, 7-213897, 9-235318, 9-302026, 11-21321, WO99/21901, WO99/19372, JP-A No. 5-140213, Japanese Patent Application National Publication (Laid-Open) No. 11-506488 and the like.

As the polyvinylamine and derivatives thereof, various known polyvinylamines and their derivatives may be used. Examples of such a derivative are the same as those of the aforementioned polyallylamine. Specific examples of the polyvinylamine and its derivatives include the compounds described in JP-B Nos. 5-35162, 5-35163, 5-35164, 5-88846, JP-A Nos. 7-118333, 2000-344990, JP Nos. 2648847, 2661677 and the like.

Among the above compounds, a polyallylamine and its derivatives are particularly preferable.

(Phenolic Compound)

The phenolic compound according to the invention is a compound having at least one aromatic hydroxy group and represents a water-soluble and hydrophobic compound. As the phenolic compound, those having a substituent are desirable and these compounds may form salts.

Examples of the above substituent include a carboxyl group, sulfo group, cyano group, halogen atom, hydroxy group, alkoxy group, aryloxy group, aliphatic group, aromatic group, acyloxy group, acyl group, phosphono group, substituted amino group and heterocyclic group.

Specific examples of these substituents are as follows.

Examples of the above halogen atom include a fluorine atom, chlorine atom and bromine atom. Examples of the above alkoxy group include alkoxy groups having 30 or less carbon atoms, for example, a methoxy group, ethoxy group, benzyloxy group, phenoxyethoxy group and phenethyloxy group. Examples of the above aryloxy group include aryloxy groups having 30 or less carbon atoms, for example, a phenoxy group, p-tolyloxy group, 1-naphthoxy group and 2-naphthoxy group.

Examples of the above aliphatic group include an alkyl group, alkenyl group, alkinyl group and aralkyl group. These groups further may have a substituent. Among these groups, an alkyl group, substituted alkyl group, alkenyl group, substituted alkenyl group, aralkyl group and substituted aralkyl group are preferable and an alkyl group and substituted alkyl group are particularly preferable. Also, the aforementioned aliphatic group may be either chain aliphatic groups or cyclic aliphatic groups and these chain aliphatic groups may be further branched.

Examples of the above alkyl group include straight-chain, branched and cyclic alkyl groups. The number of carbons of the alkyl group is preferably 1 to 30 and more preferably 1 to 20. The number of carbons of the alkyl portion of the substituted alkyl group is also preferably 1 to 30 and more preferably 1 to 20.

Specific examples of the above alkyl group include a methyl group, ethyl group, propyl group, butyl group, pentyl group, hexyl group, octyl group, 2-ethylhexyl group, t-octyl group, decyl group, dodecyl group, octadecyl group, cyclohexyl group, cyclopentyl group, neopentyl group, isopropyl group and isobutyl group.

Examples of the substituent of the above substituted alkyl group include a carboxyl group, sulfo group, cyano group, halogen atom (e.g., a fluorine atom, a chlorine atom and a bromine atom), hydroxy group, alkoxycarbonyl group having 30 or less carbon atoms (e.g., a methoxycarbonyl group, ethoxycarbonyl group and benzyloxycarbonyl group), aryloxycarbonyl group having 30 or less carbon atoms (e.g., a phenoxycarbonyl group), alkylsulfonylaminocarbonyl group having 30 or less carbon atoms (e.g., a methylsulfonylaminocarbonyl group and octylsulfonylaminocarbonyl group), arylsulfonylaminocarbonyl group (e.g., a toluenesulfonylaminocarbonyl group), acylaminosulfonyl group having 30 or less carbon atoms (e.g., a benzoylaminosulfonyl group, acetylaminosulfonyl group and pivaloylaminosulfonyl group), alkoxy group having 30 or less carbon atoms (e.g., a methoxy group, ethoxy group, benzyloxy group, phenoxyethoxy group and phenethyloxy group), arylthio group and alkylthio group having 30 or less carbon atoms (e.g., a phenylthio group, methylthio group, ethylthio group and dodecylthio group), aryloxy group having 30 or less carbon atoms (e.g., a phenoxy group, p-tolyloxy group, 1-naphthoxy group and 2-naphthoxy group) and nitro group.

Examples of the substituent of the above substituted alkyl group also include an alkyl group having 30 or less carbon atoms, alkoxycarbonyloxy group (e.g., a methoxycarbonyloxy group, stearyloxycarbonyloxy group and phenoxyethoxycarbonyloxy group), aryloxycarbonyloxy group (e.g., a phenoxycarbonyloxy group and chlorophenoxycarbonyloxy group), acyloxy group having 30 or less carbon atoms (e.g., an acetyloxy group and propionyloxy group), acyl group having 30 or less carbon atoms (e.g., an acetyl group, propionyl group and benzoyl group), carbamoyl group (e.g., a carbamoyl group, N,N-dimethylcarbamoyl group, morpholinocarbonyl group and piperidinocarbonyl group), sulfamoyl group (e.g., a sulfamoyl group, N,N-dimethylsulfamoyl group, morpholinosulfonyl group and piperidinosulfonyl group) and alkylsulfonyl group having 30 or less carbon atoms (e.g., a methylsulfonyl group, trifluoromethylsulfonyl group, ethylsulfonyl group, butylsulfonyl group and dodecylsulfonyl group).

Examples of the substituent of the above substituted alkyl group also include an arylsulfonyl group (e.g., benzenesulfonyl group, toluenesulfonyl group, naphthalenesulfonyl group, pyridinesulfonyl group and quinolinesulfonyl group), aryl group having 30 or less carbon atoms (e.g., a phenyl group, dichlorophenyl group, tolyl group, methoxyphenyl group, diethylaminophenyl group, acetylaminophenyl group, methoxycarbonylphenyl group, hydroxyphenyl group, t-octylphenyl group and naphthyl group), substituted amino group (e.g., an amino group, alkylamino group, dialkylamino group, arylamino group, diarylamino group and acylamino group), substituted phosphono group (e.g., a phosphono group, diethylphosphono group and diphenylphosphono group), heterocyclic group (e.g., a pyridyl group, quinolyl group, furyl group, thienyl group, tetrahydrofurfuryl group, pyrazolyl group, isooxazolyl group, isothiazolyl group, imidazolyl group, oxazolyl group, thiazolyl group, pyridazyl group, pyrimidyl group, pyrazyl group, triazolyl group, tetrazolyl group, benzooxazolyl group, benzoimidazolyl group, isoquinolyl group, thiadiazolyl group, morpholino group, piperidino group, piperazino group, indolyl group, isoindolyl group and thiomorpholino group), ureide group (e.g., a methylureide group, dimethylureide group and phenylureide group), sulfamoylamino group (e.g., dipropylsulfamoylamino group), alkoxycarbonylamino group (e.g., an ethoxycarbonylamino group), aryloxycarbonylamino group (e.g., a phenyloxycarbonylamino group), alkylsulfinyl group (e.g., a methylsulfinyl group), arylsulfinyl group (e.g., a phenylsulfinyl group), silyl group (e.g., a trimethoxysilyl group and triethoxysilyl group) and silyloxy group (e.g., a trimethylsilyloxy group).

It should be noted that the aforementioned carboxyl group, sulfo group, hydroxy group and phosphono group which are the substituents of the substituted alkyl group may respectively form a salt. As a cation used for forming salts, organic cationic compounds, transition metal-coordinated complex cations (e.g., compounds described in JP No. 2791143) or metal cations (e.g., Na⁺, K⁺, Li⁺, Ag⁺, Fe²⁺, Fe³⁺, Cu⁺, Cu²⁺, Zn²⁺, Al³⁺ or ½Ca²⁺) are preferable.

Examples of the above organic cationic compounds include quaternary ammonium cations, quaternary pyridinium cations, quaternary quinolinium cations, phosphonium cations, iodonium cations, sulfonium cations and dye cations.

Specific examples of the aforementioned quaternary ammonium cations include a tetraalkylammonium cations (e.g., a tetramethylammonium cation and tetrabutylammonium cation) and tetraarylammonium cations (e.g., tetraphenylammonium cation). Examples of the aforementioned quaternary pyridinium cations include N-alkylpyridinium cations (e.g., an N-methylpiridinium cation), N-arylpyridinium cations (e.g., an N-phenylpyridinium cation), N-alkoxypyridinium cations (e.g., a 4-phenyl-N-methoxy-pyridinium cation) and N-benzoylpyridinium cation. Examples of the aforementioned quinolinium cations include an N-alkylquinolinium cations (e.g., an N-methylquinolinium cation) and N-arylquinolinium cations (e.g., an N-phenylquinolinium cation). Examples of the aforementioned phosphonium cations include a tetraarylphosphonium cations (e.g., tetraphenylphosphonium cation). Examples of the aforementioned iodonium cations include a diaryliodonium cations (e.g., a diphenyliodonium cation). Examples of the aforementioned sulfonium cations include a triarylsulfonium cations (e.g., a triphenylsulfonium cation).

Further, examples of the cations that form salts may include compounds described in the paragraphs No. 0020 to No. 0038 in JP-A No. 9-188686.

Examples of the alkenyl group included in the aforementioned aliphatic group are straight-chain, branched and cyclic alkenyl groups. The number of carbons of the alkenyl group is preferably 2 to 30 and more preferably 2 to 20. The number of carbons of the alkenyl portion of the substituted alkenyl group is also preferably 2 to 30 and more preferably 2 to 20. Specific examples of the alkenyl group include a vinyl group, allyl group, pulenyl group, geranyl group, oleyl group, cycloalkenyl group (e.g., 2-cyclopentene-1-yl group and 2-cyclohexene-1-yl group), bicyclo[2,2,1]hepto-2-ene-1-yl and bicyclo[2,2,2]octo-2-ene-4-yl. Specific examples of the substituent of the substituted alkenyl group include the same substituents as in the case of the aforementioned substituted alkyl group.

Examples of the alkinyl group included in the aforementioned aliphatic group are straight-chain, branched and cyclic alkinyl groups. The number of carbons of the alkinyl group is preferably 2 to 30 and more preferably 2 to 20. The number of carbons of the alkinyl portion of the substituted alkinyl group is also preferably 2 to 30 and more preferably 2 to 20. Specific examples of the alkinyl group include an ethynyl group, propalgyl group and trimethylsilylethynyl group. Specific examples of the substituent of the substituted alkinyl group include the same substituents as in the case of the aforementioned alkyl group.

Examples of the alalkyl group included in the aforementioned aliphatic group are straight-chain, branched and cyclic alalkyl groups. The number of carbons of the alalkyl group is preferably 7 to 35 and more preferably 7 to 25. The number of carbons of the alalkyl portion of the substituted alalkyl group is also preferably 7 to 35 and more preferably 7 to 25. Specific examples of the alalkyl group include a benzyl group, methylbenzyl group, octylbenzyl group, dodecylbenzyl group, hexadecylbenzyl group, dimethylbenzyl group, octyloxybenzyl group, octadecylaminocarbonylbenzyl group and chlorobenzyl group. Specific examples of the substituent of the substituted alalkyl group include the same substituents as in the case of the aforementioned substituted alkyl group.

Examples of the aforementioned aromatic group include an aryl group and substituted aryl group and the number of carbons of the aryl group is preferably 6 to 30 and more preferably 6 to 20. The number of carbons of the aryl portion of the substituted aryl group is also preferably 6 to 30 and more preferably 6 to 20. Specific examples of the aryl group include a phenyl group, a-naphthyl group and β-naphthyl group.

Examples of the aforementioned acyloxy group include an acyloxy group having 30 or less carbon atoms and an acetyloxy group and propionyloxy group.

Examples of the acyl group are an aliphatic acyl group, aromatic acyl group and heterocyclic acyl group. The number of carbons of the acyl group is preferably 1 to 30 and more preferably 1 to 20. The number of carbons of the acyl group portion of the substituted acyl group is also preferably 1 to 30 and more preferably 1 to 20.

Specific examples of the acyl group include an acetyl group, propionyl group, pivaloyl group, chloroacetyl group, trifluoroacetyl group, 1-methylcyclopropylcarbonyl group, 1-ethylcyclopropylcarbonyl group, 1-benzylcyclopropylcarbonyl group, benzoyl group, 4-methoxybenzoyl group, pyridylcarbonyl group and thenoyl group.

Examples of the aforementioned phosphono group include a phosphono group, diethylphosphono group and diphenylphosphono group. The phosphono group may form a salt.

Examples of the aforementioned substituted amino group include an amino group, alkylamino group, dialkylamino group, arylamino group, diarylamino group and acylamino group. Examples of the substituted phosphono group include a phosphono group, diethylphosphono group and diphenylphosphono group.

Examples of the aforementioned heterocyclic group include heterocyclic groups containing a nitrogen atom, oxygen atom and sulfur atom, for example a furyl group, thienyl group, pyridyl group, pyrazolyl group, isooxazolyl group, isothiazolyl group, imidazolyl group, oxazolyl group, thiazolyl group, pyridazyl group, pyrimidyl group, pyrazyl group, triazolyl group, tetrazolyl group, quinolyl group, benzothiazolyl group, benzooxazolyl group, benzoimidazolyl group, isoquinolyl group, thiadiazolyl group, morpholino group, piperidino group, thiomorpholino group, tetrahydrofurfuryl group, piperazino group, indolyl group and isoindolyl group. These heterocyclic groups may further have a substituent. Examples of the substituent of the substituted heterocyclic group include the same substituents as in the case of the aforementioned substituted alkyl group.

The substituent of the aforementioned phenolic compound may be further substituted with the same substituent as in the case of the aforementioned substituted alkyl group.

The phenolic compound according to the invention is preferably those soluble in water and those having at least one substituent selected from a carboxyl group, sulfo group and salts thereof.

Specific examples of the phenolic compound according to the invention will be shown below; however these examples are not intended to be limiting of the invention.

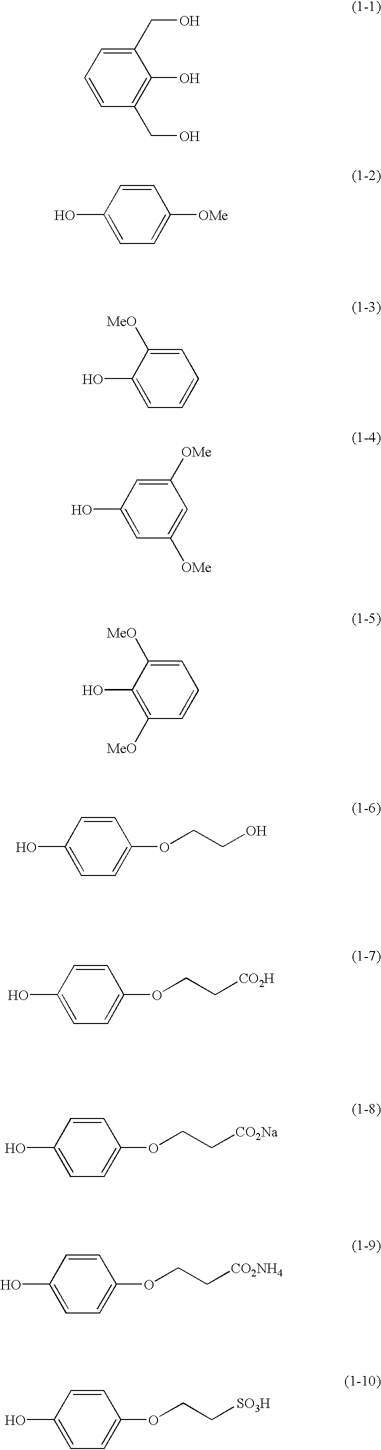

When the phenolic compound according to the invention is to be contained in the colorant-receiving layer, it may be added in the condition that the hydrophilicity thereof to water is heightened by mixing a water-soluble organic solvent, for example, an alcohol compound (e.g., methanol, ethanol, isopropyl alcohol, ethylene glycol, diethylene glycol, diethylene glycol monobutyl ether, polyethylene glycol, polypropylene glycol, glycerol, diglycerol, trimethylolpropane or trimethylolbutane), an ether compound (tetrahydrofuran or dioxane), an amide compound (e.g., dimethylformamide, dimethylacetamide or N-methylpyrrolidone) or ketone compound (e.g., acetone).

When the phenolic compound according to the invention has only insufficient water-solubility, a hydrophobic organic solvent, for example, an ester compound (e.g., ethyl acetate, dioctyl adipate, butyl phthalate, methyl stearate or tricrezylphosphate), an ether compound (e.g., anisole, hydroxyethoxybenzene or hydroquinone dibutyl ether), a hydrocarbon compound (e.g., toluene, xylene or diisopropylnaphthalene), an amide compound (e.g., N-butylbenzenesulfonamide or stearic acid amide), an alcohol compound (2-ethylhexyl alcohol, benzyl alcohol or phenethyl alcohol), a ketone compound (e.g., hydroxyacetophenone, benzophenone or cyclohexane) or the aforementioned water-soluble organic solvent may be mixed therewith and the resulting mixture may be added. The form when the resulting mixture is added may be an oil droplet, latex, solid dispersion or polymer dispersion.

The content of the above phenolic compound in the colorant-receiving layer is preferably 0.01 to 5 g/m² and more preferably 0.05 to 3 g/m².

(Fine Particle)

The colorant-receiving layer of the inkjet recording sheet acquires a porous structure by containing a fine particle and this improves ink absorbancy. It is preferable, particularly when the solid content of the fine particle in the colorant-receiving layer is 50 mass % or more, and more preferably exceeds 60 mass %, because a better porous structure can be formed, whereby an inkjet recording sheet having sufficient ink absorbancy is obtained. Here, the solid content of the fine particle in the colorant-receiving layer denotes a content calculated based on components other than water in the composition constituting the colorant-receiving layer.

The fine particle used in the invention may be either an organic fine particle or an inorganic fine particle.

Preferable examples of the organic fine particle include polymer fine particles obtained by emulsion polymerization, microemulsion type polymerization, soap-free polymerization, seed polymerization, dispersion polymerization, suspension polymerization or the like. Specific examples of the organic fine particle include powders, latexes and emulsion polymer fine particles of polyethylene, polypropylene, polystyrene, polyacrylate, polyamide, silicon resin, phenol resin and natural polymers and the like.

Examples of the inorganic fine particle include a silica fine particle, colloidal silica, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina, aluminum silicate, calcium silicate, magnesium silicate, zirconium oxide, zirconium hydroxide, cerium oxide, lanthanum oxide and yttrium oxide. Among these compounds, a silica fine particle, colloidal silica, alumina fine particle or pseudo-boehmite is preferable from the viewpoint of the formation of a good porous structure. These fine particles may be used as primary particles, or formed into and used as secondary particles. The average primary particle diameter of these fine particles is preferably 2 μm or less and more preferably 200 nm or less.

In the invention, the use of an inorganic fine particle is preferable from the viewpoint of ink absorbancy and image stability. Further, silica fine particles having an average primary particle diameter of 20 nm or less, colloidal silicas having an average primary particle diameter of 30 nm or less, alumina fine particles having an average fine particle diameter of 20 nm or less or pseudo-boehmite having an average pore diameter of 2 to 15 nm is more preferable. Particularly, silica fine particles, alumina fine particles and pseudo-boehmites are preferable.

Silica fine particles are generally classified roughly into wet method particles and dry method (vapor-phase method) particles based on the production method thereof. Among the wet methods, a method in which an active silica is produced by acid-decomposition of a silicate and properly polymerized and the polymerized silica is coagulated and sedimented to obtain hydrate silica is predominantly used. On the other hand, among the vapor-phase methods, methods for obtaining anhydrous silica using the following processes are dominantly used: a name hydrolysis method involving high temperature vapor-phase hydrolysis of a silicon halide and an arc method in which quartz sand and cokes are reduced under heating and vaporized by an arc in an electric furnace and the resulting vapor is oxidized by air. The “vapor-phase method silica” denotes the anhydrous silica fine particle obtained by the vapor-phase method. As the silica fine particle to be used in the invention, the vapor-phase method silica fine particle is particularly desirable.

The vapor-phase method silica differ from the hydrate silica in the density of a silanol group on the surface, the presence or absence of a aperture and the like in qualities exhibited. The vapor-phase method silica is suitable for the purpose of forming a three-dimensional structure having a high aperture ratio. Although the reason for this is unclear, it is estimated that in the case of hydrate silica, the density of a silanol group on the surface of a fine particle is as many as 5 to 8/nm² and the silica fine particles easily aggregated densely, whereas in the case of the vapor-phase method silica, the density of a silanol group on the surface of a fine particle is as small as 2 to 3/nm², so that the silica tends to form a non-dense flocculate with the result that the vapor-phase method silica has a structure with a high aperture ratio.

The vapor-phase method silica has the characteristics wherein because it has a particularly large specific surface area, it has high ink absorbancy and ink retention and also because it has a low refractive index, providing the receptor layer with transparency and a high color density and good color developing ability can be obtained if the silica is dispersed until the silica particle is decreased to an appropriate particle diameter. It is important for the receptor layer to be transparent with the view of obtaining a high color density and good color developing ability and glossiness not only for use in, for example, OHPs for which transparency is required, but also in the case of applying this sheet to recording sheets such as photo-glossy paper.

The average primary particle diameter of the aforementioned vapor-phase method silica is preferably 30 nm or less, more preferably 20 nm or less, particularly preferably 10 nm or less and most preferably 3 to 10 nm. The aforementioned vapor-phase method silica can form a structure having a large aperture ratio and improve the ink absorbing characteristics efficiently when the average primary particle diameter is 30 nm or less because the particles are easily stuck together due to a hydrogen bonding of a silanol group.

Also, the silica fine particle may be used in combination with the other aforementioned fine particles. When other fine particle are used together with the aforementioned vapor-phase method silica, the amount of the vapor-phase method silica in the total amount of fine particles is preferably 30 mass % or more, and more preferably 50 mass % or more.

As the inorganic fine particle to be used in the invention, an alumina fine particle, alumina hydrate and a mixture or complex of these materials are preferable. Among these materials, the alumina hydrate is preferable because it absorbs and fixes ink well and a pseudo-boehmite (Al₂O₃.nH₂O) is particularly preferable. Although as the alumina hydrate, those in various forms may be used, boehmite sol is preferably used as raw material because a smooth layer is easily obtained thereby.

As to the pore structure of the pseudo-boehmite, the average pore radius is preferably 1 to 30 nm and more preferably 2 to 15 nm. Also, the pore volume is preferably 0.3 to 2.0 cc/g (ml/g) and more preferably 0.5 to 1.5 cc/g (ml/g). Here, measurements of the aforementioned pore radius and pore volume are made by a nitrogen absorbing and desorbing method. The measurements can be made using, for example, a gas absorbing and desorbing analyzer (e.g., Omnisorp 369 (Trademark), manufactured by Coaltar).

Also, among alumina fine particles, a vapor-phase method alumina fine particle has a large specific surface area and is hence preferable. The average primary particle diameter of the vapor-phase method alumina is preferably 30 nm or less and more preferably 20 nm or less.

When the aforementioned fine particles are used for the inkjet recording sheet, they may also be preferably used in the aspects disclosed in each publication of JP-A Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, 2001-301314 and the like.

(Water-Soluble Resin)

Examples of the water-soluble resin include polyvinyl alcohol-based resins which have a hydroxy group as a hydrophilic structure unit [e.g., a polyvinyl alcohol (PVA), acetocetyl modified polyvinyl alcohol, cation modified polyvinyl alcohol, anion modified polyvinyl alcohol, silanol modified polyvinyl alcohol and polyvinylacetal], cellulose-based resins [e.g., methyl cellulose (MC), ethyl cellulose (EC), hydroxyethyl cellulose (HEC), carboxymethyl cellulose (CMC), hydroxypropyl cellulose (HPC), hydroxyethylmethyl cellulose and hydroxypropylmethyl cellulose], chitins, chitosans, starch, resins having an ether bond [e.g., polyethylene oxide (PEO), polypropylene oxide (PPO), polyethylene glycol (PEG) and polyvinyl ether (PVE)] and resins having a carbamoyl group [e.g., polyacrylamide (PAAM), polyvinylpyrrolidone (PVP) and polyacrylic acid hydrazide].

Also, polyacrylates, maleic acid resins, alginates and gelatins which have a carboxyl group as a dissociable group may be given as examples.

Among the above resins, particularly polyvinyl alcohol-based resins are preferable. Examples of the polyvinyl alcohol include those described in JP-B Nos. 4-52786, 5-67432, 7-29479, JP No. 2537827, JP-B No. 7-57553, JP Nos. 2502998, 3053231, JP-A No. 63-176173, JP No. 2604367, JP-A Nos. 7-276787, 9-207425, 11-58941, 2000-135858, 2001-205924, 2001-287444, 62-278080, 9-39373, JP No. 2750433, JP-A Nos. 2000-158801, 2001-213045, 2001-328345, 8-324105, 11-348417 and the like.

Also, examples of water-soluble resins other than polyvinyl alcohol-based resins include compounds described in the paragraphs No. 0011 to No. 0014 of the publication of JP-A No. 11-165461.

These water-soluble resins may be used either singly or in combinations of two or more. The content of the aforementioned water-soluble resin is preferably 9 to 40 mass % and more preferably 12 to 33 mass % relative to the total mass of solid components of the colorant-receiving layer.

The aforementioned water-soluble resin and the aforementioned fine particle primarily constituting the colorant-receiving layer of the inkjet recording sheet may respectively be a single raw material or may use a mix of raw materials.

The type of water-soluble resin to be combined with a fine particle, especially a silica fine particle, is important for maintaining transparency. When the aforementioned vapor-phase method silica is used, polyvinyl alcohol type resins are preferable as the water-soluble resin. Among these resins, polyvinyl alcohol type resins having a saponification degree of 70 to 100% are more preferable and polyvinyl alcohol type resins having a saponification degree of 80 to 99.5% are particularly preferable.

The aforementioned polyvinyl alcohol type resin has a hydroxyl group in its structural unit. Because this hydroxyl group and a silanol group on the surface of the aforementioned silica fine particle form a hydrogen bond, a three-dimensional network structure in which a secondary particle of the silica fine particle forms a network chain unit is easily formed. It is thought that a colorant-receiving layer having a porous structure with a high aperture ratio and sufficient strength is formed by the formation of this three-dimensional network structure.

In inkjet recording, the porous colorant-receiving layer obtained in the above manner absorbs ink rapidly by a capillary phenomenon and can form a highly circular dot that is free from ink-bleeding.

Also, the polyvinyl alcohol type resin may be used in combination with the aforementioned other water-soluble resins. When a combination of other water-soluble resins and the aforementioned polyvinyl alcohol type resin is used, the content of the polyvinyl alcohol type resin in the total water-soluble resin is preferably 50 mass % or more and more preferably 70 mass % or more.

<Ratio of the Mass of the Fine Particle to the Mass of the Water-Soluble Resin>

The content mass ratio of the fine particle (x) to the water-soluble resin (y) [PB ratio (x/y)] in the colorant-receiving layer greatly affects the film structure and also film strength of the colorant-receiving layer. Namely, as the content mass ratio [PB ratio] increases, the aperture ratio, pore volume and surface area (per unit mass) increase, but the density and strength tend to decrease.

The aforementioned content mass ratio [PB ratio (x/y)] of the colorant-receiving layer according to the invention is preferably 1.5 to 10 with the view of preventing the film strength from being reduced and the film from being cracked, during drying, because of an excess PB ratio and also preventing the ink absorbancy from being reduced resulting from the aperture being easily clogged by the resin and from the aperture ratio being reduced because of an excessively small PB ratio.

When a recording sheet is passed through a carrier system of an inkjet printer, stress may be applied to the recording sheet. Therefore, it is necessary for the colorant-receiving layer to have sufficient film strength. Also, the colorant-receiving layer must have sufficient film strength to prevent the cracking and the peeling of the colorant-receiving layer when the recording sheet is cut into sheets. Taking these cases into account, the aforementioned mass ratio (x/y) is more preferably 5 or less, whereas it is preferably 2 or more with the view of securing high speed ink absorbancy in an inkjet printer.

For instance, when a coating liquid prepared by thoroughly dispersing a vapor-phase method silica fine particle having an average primary particle diameter of 20 nm or less and a water-soluble resin in a mass ratio (x/y) of 2 to 5 in an aqueous solution is applied to a support and the applied layer is dried, a three-dimensional network structure in which a secondary particle of the silica fine particle forms a network chain unit is formed, so that a translucent porous film having an average pore diameter of 30 nm or less, a aperture ratio of 50 to 80%, a pore specific volume of 0.5 ml/g or more and a specific surface area of 100 m²/g or more can be formed with ease.

(Crosslinking Agent)

In a preferred aspect of the colorant-receiving layer of the inkjet recording sheet of the invention, the coated layer containing the water-soluble resin further contains a crosslinking agent capable of crosslinking the water-soluble resin. In a more preferred aspect of the colorant-receiving layer of the inkjet recording sheet of the invention, the coated layer contains both the fine particles and the water-soluble resin, and the coated layer is a porous layer, which is cured by the crosslinking reaction between the crosslinking agent and the water-soluble resin.

For the crosslinking of the aforementioned water-soluble resin, especially, a polyvinyl alcohol-based resin and a boron compound are desirable. Examples of the boron compound may include borax, boric acid and borates (e.g., orthoborates, InBO₃, ScBO₃, YBO₃, LaBO₃, Mg₃(BO₃)₂, Co₃(BO₃)₂, diborates (e.g., Mg₂B₂O, and Co₂B₂O₅), methaborates (e.g., LiBO₂, Ca(BO₂)₂, NaBO₂ and KBO₂), tetraborates (e.g., Na₂B₄O₇.10H₂O) and pentaborates (e.g., KB₅O₈.4H₂O, Ca₂B₆O₁₁.7H₂O and CsB₅O₅)). Among these boron compounds, borax, boric acid and borates are preferable and boric acid is particularly preferable because these boron compounds cause a crosslinking reaction promptly.

As a crosslinking agent for the aforementioned water-soluble resin, the following compound other than boron compounds may be used.

Examples of the crosslinking agent include aldehyde-based compounds such as formaldehyde, glyoxal, succinaldehyde glutaraldehyde, dialdehyde starch, dialdehyde derivatives of plant gum; ketone-based compounds such as diacetyl, 1,2-cyclopentanedione and 3-hexene-2,5-dione; active halogen compounds such as bis(2-chloroethyl)urea, bis(2-chloroethyl)sulfone, 2,4-dichloro-6-hydroxy-S-triazine.sodium salt; active vinyl compounds such as divinylsulfone, 1,3-bis(vinylsulfonyl)-2-propanol, N,N-ethylenebis(vinylsulfonylacetamide), divinylketone, 1,3-bis(acryloyl)urea and 1,3,5-triacryloyl-hexahydro-S-triazine; N-methylol compounds such as dimethylolurea and methyloldimethylhydantoin; melamine compounds such as trimethylolmelamine, alkylated methylolmelamine, melamine, benzoguanamine and melamine resin; epoxy compounds such as ethyleneglycol diglycidylether, propyleneglycol diglycidylether, polyethyleneglycol diglycidylether, diglycerin polyglycidylether, spyroglycol diglycidylether, polyglycidylether of phenol resin;

isocyanate-based compounds such as 1,6-hexamethylenediisocyanate and xylylenediisocyanate; aziridine type compounds described in each of U.S. Pat. Nos. 3,017,280 and 2,983,611; carbodiimide-based type compounds described in U.S. Pat. No. 3,100,704; ethyleneimino-based compounds such as 1,6-hexamethylene-N,N′-bisethyleneurea; halogenated carboxyaldehyde-based compounds such as mucochloric acid and mucophenoxychloric acid; dioxane-based compounds such as 2,3-dihydroxydioxane; compounds that include metal such as titanium lactate, aluminum sulfate, chrome alum, potassium alum, zirconyl acetate and chromium acetate; polyamine compounds such as tetraethylenepentamine; hydrazide compounds such as dihydrazide adipate; and low-molecular weight compounds or polymers having two or more oxazoline groups; multivalent acid anhydrides described in each of U.S. Pat. Nos. 2,725,294, 2,725,295, 2,726,162 and 3,834,902; acid chlorides; bissulfonate compounds; active ester compounds described in each of U.S. Pat. Nos. 3,542,558 and 3,251,972.

The aforementioned crosslinking agents may be used either singly or in combinations of two or more.

The crosslinking and curing are preferably carried out by adding a crosslinking agent to a coating liquid (hereinafter sometimes referred to as “coating liquid A”) containing the fine particle, the water-soluble resin and the like and/or the following basic solution, and by adding a basic solution (hereinafter sometimes referred to as “coating liquid B”) having a pH of 8 or more to a coated layer either (1) at the same time when the coating liquid A is applied to form the coated layer or (2) before the coated layer shows the decreasing rate of drying during the course of drying the coated layer formed by applying the coating liquid A. The provision of the aforementioned crosslinking agent is preferably made in the following manner taking the case of a boron compound as an example. To state in more detail, when the colorant-receiving layer is a layer obtained by crosslinking and curing a coated layer prepared by applying a coating liquid (coating liquid A) containing the fine particle and the water-soluble resin containing polyvinyl alcohol, the crosslinking and curing are preferably carried out by adding a basic solution (coating liquid B) having a pH of 8 or more to the coated layer (1) at the same time when the coating liquid A is applied to form the coated layer, or (2) before the coated layer shows the decreasing rate of drying during the course of drying the coated layer formed by applying the coating liquid A. The boron compound may be contained as the crosslinking agent in either the coating liquid A or the coating liquid B or may be contained in both the coating liquid A and the coating liquid B.

The amount of the crosslinking agent to be used is preferably 1 to 50 mass % and more preferably 5 to 40 mass %.

(Other Mordants)

In the invention, other mordants shown below may be used together with the organic mordant according to the invention to improve the water resistance of the formed image and the bleeding of the formed image with time.

As other mordants, cationic polymers (cationic mordants) as organic mordants or inorganic mordants are preferable. Including the mordant in the colorant-receiving layer allows the mordant to interact with liquid ink containing an anionic dye as a colorant to stabilize the colorant, whereby the water resistance and the resistance to bleeding over time can be improved. The organic mordant and the inorganic mordant may be used either independently or in combination with each other.

The mordant is made to be present such that the thickness of the portion where the mordant is present is 10 to 60%, and preferably 20 to 40%, of the thickness of the receptor layer. When the thickness of the mordant portion is less than 10%, the bleeding over time may increase whereas when the thickness of the mordant portion exceeds 60%, the color density and the ozone resistance may decrease.

As to a method for making the thickness of the portion where the mordant is present fall within the above range, a mordant layer having a predetermined thickness may be formed using an optional method, for example: (1) a method in which a coated layer containing the fine particle and the water-soluble resin is formed and a solution containing the mordant is applied or (2) a method in which a coating liquid containing the fine particle and the water-soluble resin and a solution containing the mordant were applied in an overlaying manner to form a multilayer. Also, the inorganic fine particle, water-soluble resin and crosslinking agent may be contained in the mordant-containing solution.

As the above cationic mordant, a polymer mordant containing primary to tertiary amino groups or a quaternary ammonium salt group as a cationic group is used. A cationic non-polymer mordant may also be used.

As the aforementioned polymer mordant, those obtained as a homopolymer of a monomer (mordant monomer) having primary to tertiary amino groups and salts thereof or a quaternary ammonium salt group, or as a copolymer or a condensed polymer of the mordant monomer and other monomers (hereinafter refereed to as “non-mordant monomer”) are preferable. Also, these polymer mordants may be used in any of the forms of a water-soluble polymer and a water-dispersible latex particle.

Examples of the aforementioned monomer (mordant monomer) include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride;

trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl-N-2-(4-vinylphenyl) ethylammonium acetate;

methyl chloride, ethyl chloride, methyl bromide, ethyl bromide, methyl iodide or quaternary compounds of ethyl iodide of N,N-dimethylaminoethyl(meth)acrylate, N,N-diethylaminoethyl(meth)acrylate, N,N-dimethylaminopropyl(meth)acrylate, N,N-diethylaminopropyl(meth)acrylate, N,N-dimethylaminoethyl(meth)acrylamide, N,N-diethylaminoethyl(meth)acrylamide, N,N-dimethylaminopropyl(meth)acrylamide and N,N-diethylaminopropyl(mcth)acrylamide or sulfonates, alkylsulfonates, acetates or alkylcarboxylates obtained by substituting anions of these compounds.

Specific examples of these salts include monomethyldiallylammonium chloride, trimethyl-2-(methacryloyloxy)ethylammonium chloride, triethyl-2-(methacryloyloxy)ethylamrnonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acryloylamino)ethylammonium chloride, triethyl-2-(aryloylamino)ethylammonium chloride, trimethyl-3-(methacryloylamino)propylammonium chloride, triethyl-3-(methacryloylamino)propylammonium chloride, trimethyl-3-(acryloylamino) propylammonium chloride, triethyl-3-(acryloylamino)propylammonium chloride, N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy) ethylammonium bromide, trimethyl-3-(acryloylamino)propylammonium bromide, trimethyl-2-(methacryloyloxy)ethylammonium sulfonate and trimethyl-3-(acryloylamino)propylammonium acetate.

Other than the above, N-vinylimidazole and N-vinyl-2-methylimidazole are given as examples of a copolymerizable monomer.

Also, allylamine, diallylamine and their derivatives and salts may be utilized. Examples of these compound include allylamine, allylamine hydrochloride, allylamine acetate, allylamine sulfate, diallylamine, diallylamine hydrochloride, diallylamine acetate, diallylamine sulfate, diallylmethylamine and salts thereof (examples of the salts include hydrochlorides, acetates and sulfates), diallylethylamine and salts thereof (examples of the salt include hydrochlorides, acetates and sulfates), diallyldimethylammonium salts (examples of a counter anion of the salt include chlorides, acetic acid ions and sulfuric acid ions). It should be noted that these allylamines and diallylamine derivatives are generally polymerized in the form of a salt and then desalted according to the need because they are inferior in polymerizing ability when they are in an amine state.

Also, a unit of N-vinylacetamide or N-vinylformamide may be used and converted into a vinylamine unit by hydrolysis after polymerized and salts of these compounds may also be utilized.

The aforementioned non-mordant monomers denote monomers, which exclude primary to tertiary amino groups or salts thereof or a basic or cationic portion such as a quaternary ammonium base and do not exert an interaction with a dye contained in inkjet ink or exert a substantially small interaction with the dye.

Examples of the aforementioned non-mordant monomer include alkyl(meth)acrylates; cycloalkyl(meth)acrylates such as cyclohexyl(meth)acrylate; aryl(meth)acrylates such as phenyl(meth)acrylate; aralkyl esters such as benzyl(meth)acrylate; aromatic vinyls such as styrene, vinyltoluene and a-methylstyrene; vinyl esters such as vinyl acetate and vinyl propionate; allyl esters such as allyl acetate; halogen-containing monomers such as vinylidene chloride and vinyl chloride; vinyl cyanates such as (meth)acrylonitrile; and olefins such as ethylene and propylene.

As the aforementioned alkyl(meth)acrylate, alkyl(meth)acrylates with an alkyl portion having 1 to 18 carbon atoms are preferable. Examples of the alkyl(meth)acrylates include methyl(meth)acrylate, ethyl(meth)acrylate, propyl(meth)acrylate, isopropyl(meth)acrylate, n-butyl(meth)acrylate, isobutyl(meth)acrylate, t-butyl(meth)acrylate, hexyl(meth)acrylate, octyl(meth)acrylate, 2-ethylhexyl(meth)acrylate, lauryl(meth)acrylate and stearyl(meth)acrylate. Among these compounds, methylacrylate, ethylacrylate, methylmethacrylate, ethylmethacrylate and hydroxyethylmethacrylate are preferable. The aforementioned non-mordant monomers may be used either singly or in combinations of two or more.

Further, preferable examples of the aforementioned polymer mordant may include polydiallyldimethylammonium chloride, polymethacryloyloxyethyl-β-hydroxyethyldimethylammonium chloride, polyethyleneimine, polyamido-polyamine resins, cationic starch, dicyandiamidoformalin condensates, dimethyl-2-hydroxypropylammonium salt polymers, polyamidine, dicyan type cationic resins represented by a dicyandiamido-formalin polycondensate, polyamine type cationic resins represented by dicyanamido-diethylenetriamine polycondensate, epichlorohydrin-dimethylamine addition polymer, dimethyldialliinammonium chloride-SO₂ copolymers, diallylamine salt-SO₂ copolymers, (meth)acrylate-containing polymers having a quaternary ammonium base substituted alkyl group at the ester portion and styryl type polymers having a quaternary ammonium base substituted alkyl group.

Specific examples of the aforementioned polymer mordant include those described in: JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134 and 1-161236, U.S. Pat. Nos. 2,484,430, 2,548,564, 3148061, 3309690, 4115124, 4124386, 4193800, 4273853, 4282305 and 4450224, and JP-A Nos. 1-161236, 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, 2001-301314, JP-B Nos. 5-35162, 5-35163, 5-35164, 5-88846, JP-A Nos. 7-118333, 2000-344990, JP Nos. 2648847 and 2661677.

When the phenolic compound according to the invention made to be contained in the colorant-receiving layer, an organic acid or an inorganic acid may be added. The acid may be mixed with the phenolic compound in advance or may be mixed by applying a coating liquid containing the phenolic compound either simultaneously or successively.

The surface pH of the colorant-receiving layer is adjusted to be from 3 to 8 and preferably from 5 to 7.5 by adding an acid. This is preferable because the anti-yellowing characteristics of a white ground portion is improved. The surface pH is measured according to the A method (application method) among the surface pH-measuring methods determined by Japan Technical Association of Paper Pulp Industries (J. TAPPI). For instance, the measurement can be made using a paper pH measurement set “Form MPC” which corresponds to the above A method and manufactured by Kyoritsu Rikagaku Kenkyujyo.

Specific examples of the acid include formic acid, acetic acid, glycolic acid, oxalic acid, propionic acid, malonic acid, succinic acid, adipic acid, maleic acid, malic acid, tartaric acid, citric acid, benzoic acid, phthalic acid, isophthalic acid, glutaric acid, gluconic acid, lactic acid, aspartic acid, glutamic acid, salicylic acid, metal salts of salicylic acid (salts of Zn, Al, Ca, Mg and the like), methanesulfonic acid, itaconic acid, benzenesulfonic acid, toluenesulfonic acid, trifluoromethanesulfonic acid, styrenesulfonic acid, trifluoroacetic acid, barbituric acid, acrylic acid, methacrylic acid, cinnamic acid, 4-hydroxybenzoic acid, aminobenzoic acid, naphthalenedisulfonic acid, hydroxybenzenesulfonic acid, toluenesulfinic acid, benzenesulfinic acid, sulfanilic acid, sulfamic acid, α-resorcylic acid, β-resorcylic acid, γ-resorcylic acid, gallic acid, fluoroglycine, sulfosalicylic acid, ascorbic acid, erysorbic acid, bisphenolic acid, hydrochloric acid, nitric acid, sulfuric acid, phosphoric acid, polyphosphoric acid, boric acid and boronic acid. The amount of each of these acids may be determined such that the surface pH of the colorant-receiving layer is from 3 to 8.

The above acids may be used in the state of a metal salt (e.g., salts of sodium, potassium, calcium, cesium, zinc, copper, iron, aluminum, zirconium, lanthanum, yttrium, magnesium, strontium or cerium) or in the state of an amine salt (e.g., ammonia, triethylamine, tributylamine, piperazine, 2-methylpiperazine and polyallylamine).

(Other Components)

The inkjet recording sheet of the invention may further contain various known additives according to the need. Examples of these additives include ultraviolet absorbers, antioxidants, fluorescent whitening agents, monomers, polymerization initiators, polymerization inhibitors, anti-bleeding agents, antiseptics, viscosity stabilizers, antifoaming agent, surfactants, antistatic agents, matt agents, anti-curling agents and waterproof agents.

It is preferable to use the phenolic compound according to the invention in combination with fastness improvers such as an ultraviolet absorber, antioxidant and anti-bleeding agent.

Examples of these ultraviolet absorber, antioxidant and anti-bleeding agent which may be used together include alkylated phenolic compounds (including hindered phenolic compounds), alkylthiomethylphenolic compounds, hydroquinone compounds, alkylated hydroquinone compounds, tocopherol compounds, thiodiphenyl ether compounds, compounds having two or more thio-ether bonds, bisphenolic compounds, O-, N- and S-benzyl compounds, hydroxybenzyl compounds, triazine compounds, phosphonate compounds, acylaminophenolic compounds, ester compounds, amide compounds, ascorbic acid, amine type antioxidants, 2-(2-hydroxyphenyl)bcnzotriazole compounds, 2-hydroxybenzophenone compounds, acrylates, water-soluble or hydrophobic metal salts, organic metal compounds, metal complexes, hindered amine compounds (including TEMPO compounds), 2-(2-hydroxyphenyl)-1,3,5-triazine compounds, metal deactivators, phosphite compounds, phosphonite compounds, hydroxyamine compounds, nitron compounds, peroxide scavengers, polyamide stabilizers, polyether compounds, basic auxiliary stabilizers, nucleic agents, benzofuranone compounds, indolinone compounds, phosphine compounds, polyamine compounds, thiourea compounds, urea compounds, hydrazide compounds, amidine compounds, sugar compounds, hydroxybenzoic acid compounds, dihydroxybenzoic acid compounds and trihydroxybenzoic acid compounds.

Among these, it is preferable to use at least one or a combination of two or more types selected from alkylated phenolic compounds, compounds having two or more thioether bonds, bisphenolic compounds, ascorbic acid, amine type antioxidants, water-soluble or hydrophobic metal salts, organic metal compounds, metal complexes, hindered amine compounds, polyamine compounds, thiourea compounds, hydrazide compounds, hydroxybenzoic acid compounds, dihydroxybenzoic acid compounds and trihydroxybenzoic acid compounds.

Specific examples of these compounds include those described in JP-A Nos. 10-182621, 2001-260519, JP-B Nos. 4-34953, 4-34513, JP-A No. 11-170686, Japanese Patent Application No. 2001-152237, JP-B No. 4-34512, EP1138509, JP-A Nos. 60-67190, 7-276808, 2001-94829, 47-10537, 58-111942, 58-212844, 59-19945, 59-46646, 59-109055, 63-53544, JP-B Nos. 36-10466, 42-26187, 48-30492, 48-31255, 48-41572, 48-54965, 50-10726, U.S. Pat. Nos. 2,719,086, 3,707,375, 3,754,919 and 4,220,711;

JP-B Nos. 45-4699, 54-5324,Europian Patent (Laid-open) Nos. 223739, 309401, 309402, 310551, 310552 and 459416, German Patent (Laid-open) No. 3435443, JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 63-88381, 63-113536; 63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437, 5-170361, JP-B Nos. 48-43295, 48-33212, U.S. Pat. Nos. 4,814,262, 4,980,275 and the like.

These other components may be used either singly or in combinations of two or more. These components may be added after they are water-solubilized, made dispersible, made polymer-dispersible, emulsified or made to be oil droplets. Also they may be encapsulated in a microcapsule. The amount of these components when they are added is preferably 0.01 to 10 g/m².

Also, the surface of the inorganic fine particle may be processed using a silane coupling agent with the intention of improving the dispersibility of the inorganic fine particle. As the silane coupling agent, those having, in addition to a portion carrying out a coupling process, an organic functional groups (e.g., a vinyl group, amino group, epoxy group, mercapto group, chloro group, alkyl group, phenyl group and ester group) are preferable.

In the invention, the colorant-receiving layer coating liquid preferably contains a surfactant. As the surfactant, all cationic type, anionic type, nonionic type, amphoteric type, fluorine type and silicon type surfactants may be used.

Examples of the above nonionic surfactant include polyoxyalkylene alkyl ethers and polyoxyalkylene alkylphenyl ethers (e.g., diethylene glycol monoethyl ether, diethylene glycol diethyl ether, polyoxyethylene lauryl ether, polyoxyethylene stearyl ether and polyoxyethylene nonylphenyl ether), oxyethylene-oxypropylene block copolymers, sorbitan fatty acid esters (e.g., sorbitan monolaurate, sorbitan monooleate and sorbitan trioleate), polyoxyethylenesorbitan fatty acid esters (e.g., polyoxyethylenesorbitan monolaurate, polyoxyethylenesorbitan monooleate and polyoxyethylenesorbitan trioleate), polyoxyethylenesorbitol fatty acid esters (e.g., polyoxyethylenesorbitol tetraoleate), glycerol fatty acid esters (e.g., glycerol monooleate), polyoxyethyleneglycerol fatty acid esters (e.g., polyoxyethyleneglycerol monostearate and polyoxyethyleneglycerol monooleate), polyoxyethylene fatty acid esters (polyethylene glycol monolaurate and polyethylene glycol monooleate), polyoxyethylenealkylamine and acetylene glycols (e.g., 2,4,7,9-tetramethyl-5-decyne-4,7-diol and ethyleneoxide adducts and propyleneoxide adducts of the diol). Among these compounds, the polyoxyalkylene alkyl ethers are preferable. The nonionic surfactant may be used in the first coating liquid and in the second coating liquid. Also, the above nonionic surfactants may be used either singly or in combinations of two or more.

Examples of the amphoteric surfactant include an amino acid type, carboxyammoniumbetaine type, an sulfonammoniumbetaine type, an ammonium sulfate betaine type and imidazolium betaine type. Examples described, for example, in U.S. Pat. No. 3,843,368, JP-A Nos. 59-49535, 63-236546, 5-303205, 8-262742, 10-282619, and the like, may be preferably used. As the amphoteric surfactant, amino acid type amphoteric surfactants are preferable. Examples of the amino acid type amphoteric surfactant include N-aminoacylic acids which are derived from an amino acids (e.g., glycine, glutamic acid and histidic acid) and into which a long-chain acyl group is introduced, and salts thereof. The aforementioned amphoteric surfactants may be used either singly or in combinations of two or more.

Examples of the aforementioned anionic surfactant include fatty acid salts (e.g., sodium stearate and potassium oleate), alkyl sulfates (e.g., sodium laurylsulfate and triethanolamine laurylsulfate), sulfonates (e.g., sodium dodecylbenzenesulfonate), alkyl sulfosuccinates (e.g., sodium dioctylsulfosuccinate), alkyl diphenyl ether disulfonates and alkyl phosphates.

Examples of the aforementioned cationic surfactant include alkylamine salts, quaternary ammonium salts, pyridinium salts and imidazolium salts.

Examples of the aforementioned fluorine type surfactant include compounds derived through an intermediate having a perfluoroalkyl group by using a method such as electrolytic fluorination, telomerization or oligomerization. For example, perfluoroalkyl sulfonates, perfluoroalkyl carboxylates, perfluoroalkylethylene oxide adducts, perfluoroalkyltrialammonium salts, perfluoroalkyl group-containing oligomers and perfluoroalkyl phosphates.

As the aforementioned silicon type surfactant, silicon oil modified by an organic group and the silicon oil may have a structure in which the side chain of a siloxane structure is modified by an organic group, a structure in which both terminals are modified or a structure in which one terminal is modified. Examples of the organic group modification include an amino modification, polyether modification, epoxy modification, carboxyl modification, carbinol modification, alkyl modification, aralkyl modification, phenol modification and fluorine modification.

The content of the surfactant in the invention is preferably from 0.001 to 2.0% and more preferably from 0.01 to 1.0% based on the colorant-receiving layer coating liquid. Also, when two or more liquids are used as the colorant-receiving layer coating liquid, it is preferable to add the surfactant to each coating liquid.

(High-Boiling Point Organic Solvent)

In the invention, the colorant-receiving layer preferably contains a high-boiling point organic solvent for preventing curling. The aforementioned high-boiling point organic solvent is a water-soluble or hydrophobic organic compound having a boiling point of 150° C. or more under normal pressure. These organic solvents may be a liquid or a solid at ambient temperature and may be a low molecule or a high molecule.

Specific examples of the organic solvent include aromatic carboxylates (e.g., dibutyl phthalate, diphenyl phthalate and phenyl benzoate), aliphatic carboxylates (e.g., dioctyl adipate, dibutyl sebacate, methyl stearate, dibutyl maleate, dibutyl fumarate and triethyl acetylcitrate), phosphates (e.g., trioctyl phosphate and tricrezyl phosphate), epoxies (e.g., epoxidated soybean oil and epoxidated fatty acid methyl), alcohols (e.g., stearyl alcohol, ethylene glycol, propylene glycol, diethylene glycol, triethylene glycol, glycerol, diethylene glycol monobutyl ether (DEGMBE), triethylene glycol monobutyl ether, glycerol monomethyl ether, 1,2,3-butanetriol, 1,2,4-butanetriol, 1,2,4-pentanetriol, 1,2,6-hexanetriol, thiodiglycol, triethanolamine and polyethylene glycol), vegetable oils (e.g., soybean oil and sunflower oil) and higher aliphatic carboxylic acids (e.g., linoleic acid and oleic acid).

(Support)

As the support, a transparent support made of a transparent material such as a plastic or an opaque support made of an opaque material such as paper may be used. It is preferable to use a transparent support or a highly glossy opaque support to make use of the transparency of the colorant-receiving layer.

Materials usable for the aforementioned transparent support are preferably those which are transparent and have qualities enough to endure radiated heat when the recording sheet is used for OHPs and back light displays. Examples of the material include polyesters such as polyethylene terephthalate (PET); polysulfones, polyphenylene oxides, polyimides, polycarbonates and polyamides. Among these materials, polyesters are preferable and polyethylene terephthalates are particularly preferable.

Although there are no particular limitations to the thickness of the aforementioned transparent support, the thickness is preferably 50 to 200 μm from the viewpoint of handling easiness.

As the highly glossy opaque support, supports for which the surface on the side on which the colorant-receiving layer is disposed have a glossiness of 40% or more are preferable. The aforementioned glossiness is defined as a value determined according to the method described in JIS P-8142 (Test method for glossiness of a 75 degree mirror surface of paper and paper board). Given as specific examples of such a support are the following supports.

Examples of the opaque support include highly glossy paper supports such as art paper, coated paper, cast coated paper and baryta paper which are used for a silver salt photographic supports; highly glossy films which are prepared and made opaque (may be processed by surface calender treatment) by including a white pigment in a plastic film such as polyesters such as polyethylene terephthalate (PET), cellulose esters such as nitrocellulose, cellulose acetate and cellulose acetate butyrate, polysulfone, polyphenylene oxide, polyimide, polycarbonate and polyamide; or supports prepared by forming a polyolefin coated layer containing or not containing a white pigment on each surface of the aforementioned various paper support, the aforementioned transparent supports or highly glossy films containing a white pigment or the like.

White pigment-containing foam polyester films (e.g., foam PETs which are made to contain a polyolefin fine particle and in which apertures are formed by drawing) may be preferably given as examples. Moreover, resin-coated paper to be used for silver salt photographic print paper is also preferable.

Although there is no particular limitations to the thickness of the aforementioned opaque support, the thickness is preferably 50 to 300 μm in view of handling characteristics.

The aforementioned supports whose surface is processed by corona discharge treatment, glow discharge treatment, flame treatment or ultraviolet radiation treatment to improve wettability and adhesiveness may be used.

Next, base paper to be used for the aforementioned resin coated paper will be explained in detail.

The aforementioned base paper is made using wood pulp as a major raw material and synthetic pulp such as polypropylene or synthetic fiber such as nylon or polyester in addition to the wood pulp as required. Although any of LBKP, LBSP, NBKP, NBSP, LDP, NDP, LUKP and NUKP may be used as the wood pulp, it is preferable to use LBKP, NBSP, LBSP, NDP and LDP, which have a high proportion of short fibers in a large amount.

However, the ratio of LBSP and/or LDP is preferably 10 mass % or more and 70 mass % or less.

As the aforementioned pulp, chemical pulps (sulfate pulp and sulfite pulp), which are reduced in impurities, are preferably used and pulps which are improved in whiteness by performing bleaching treatment, are useful.

Sizing agents such as a higher fatty acid and alkylketene dimer, white pigments such as calcium carbonate, talc and titanium oxide, paper force strengthening agents such as starch, polyacrylamide and polyvinyl alcohol, fluorescent whitening agents, water retentive agents such as polyethylene glycol, dispersants, softening agents such as quaternary ammonium, and the like may be added to the base paper as appropriate.

The freeness of the pulp used in paper-making is preferably 200 to 500 ml in terms of value according to the provision of CSF. Also, as for the fiber length after being beaten, the sum of 24 mesh residue mass % and 42 mesh residue mass % prescribed in JIS P-8207 is preferably 30 to 70%, and that the 4 mesh residue mass % is preferably 20 mass % or less.

The basis weight of the base paper is preferably 30 to 250 g and particularly preferably 50 to 200 g. The thickness of the base paper is preferably 40 to 250 μm. The base paper may be provided with high smoothhess by calendering in a paper-making stage or after paper-making. The density of the base paper is usually 0.7 to 1.2 g/m² (JIS P-8118).

Further, the rigidity of the base paper is preferably 20 to 200 g under the conditions prescribed in JIS P-8143.

A surface sizing agent may be applied to the surface of the base paper. As the surface sizing agent, the same sizing agents as those which may be added to the aforementioned base paper may be used.

The pH of the base paper is preferably 5 to 9 when measured using a hot-water extraction method prescribed in JIS P-8113.

The polyethylene with which the surface and backface of the base paper are coated is primarily low density polyethylene (LDPE) and/or high density polyethylene (HDPE). Other linear low density polyethylene (LLDPEs), polypropylene or the like may be used as a part of the polyethylene.

Particularly, the polyethylene layer on the side on which the colorant-receiving layer is formed is preferably improved in opacity, whiteness and hue by adding rutile or anatase type titanium oxide, a fluorescent whitening agent and ultramarine blue to polyethylene in the manner in which photographic print paper in a wide field is processed. Here, the content of titanium oxide is preferably about 3 to 20 mass % and more preferably 4 to 13 mass % based on the polyethylene. Although no particular limitations are imposed on the thickness of the polyethylene layer, it is preferably 10 to 50 μm on both of the surface and the backface. Further, an undercoat layer may be disposed on the polyethylene layer to impart adhesion to the colorant-receiving layer. As the undercoat layer, an aqueous polyester, gelatin and PVA are preferably used. Also, the thickness of the undercoat layer is preferably 0.01 to 5 μm.

The polyethylene coated paper may be used as glossy paper. Also, polyethylene coated paper formed with a matted surface or silky pattern surface, which is obtained from usual photographic print paper, by performing so-called marking treatment when polyethylene is melt-extruded on the surface of the base paper to carry out coating may also be used as the polyethylene coated paper.

The support may be provided with a back coat layer. Examples of compounds which may be added to the back coat layer include white pigments, aqueous binders and other components.

Examples of the white pigment contained in the back coat layer include white inorganic pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate and magnesium hydroxide and organic pigments such as styrene type plastic pigments, acrylic plastic pigments, polyethylene, microcapsules, urea resins and melamine resins.

Examples of the aqueous binder used for the back coat layer include water-soluble polymers such as a styrene/maleate copolymer, styrene/acrylate copolymer, polyvinyl alcohol, silanol modified polyvinyl alcohol, starch, cationic starch, casein, gelatin, carboxymethyl cellulose, hydroxyethyl cellulose and polyvinylpyrrolidone and water-dispersible polymers such as a styrenebutadiene latex and acrylic emulsion.

Examples of other components to be contained in the back coat layer include antifoaming agents, foam suppressors, dyes, fluorescent whitening agents, antiseptics and waterproof agents.

(Production of an Inkjet Recording Sheet)

The colorant-receiving layer of the inkjet recording sheet of the invention is preferably formed using a Wet-on-Wet method. In this method, the colorant-receiving layer is formed by a process including the steps of: preparing a coating liquid containing at least fine particles and a water-soluble resin; preparing a basic solution having a pH value of at least 8; adding a crosslinking agent to at least one of the coating liquid and the basic solution; applying the coating liquid to form a coated layer; drying the coated layer; crosslinling and curing the coated layer by adding the basic solution to the coated layer at a time that is at least one of (1) simultaneous with the step of applying the coating liquid to form the coated layer, and (2) before the coated layer exhibits a decreasing rate of drying during the step of drying the coated layer.

The crosslinking agent capable of crosslinking the aforementioned water-soluble resin is preferably contained in either one or both of the aforementioned coating liquid and basic solution. Providing of the colorant-receiving layer crosslinked and cured in the above manner is preferable from the viewpoints of ink absorbency and prevention of cracking of the film.

The mordant is made to be present such that the thickness, from the surface of the mordant, of the portion where the mordant is present is 10 to 60% of the thickness of the receptor layer. The mordant portion may be formed using a desired method such as (1) a method in which a coated layer containing the aforementioned fine particle, water-soluble resin and crosslinking agent is formed and a mordant-containing solution is applied to the coated layer and (2) a method in which the coating liquid containing the aforementioned fine particle and water-soluble resin and a mordant-containing solution are applied in an overlaying manner. Also, the aforementioned inorganic fine particle, water-soluble resin, crosslinking agent and the like may be contained in the mordant-containing solution.

The aforementioned process allows a lot of mordant to exist at a predetermined portion of the colorant-receiving layer. Therefore, the colorant of an inkjet is sufficiently mordanted and the color density, the bleeding over time, the glossiness of a print portion and the water-resistance and ozone resistance of characters and images after printing are improved and therefore, the above process is preferred. A part of the mordant may be contained in a layer formed first on the support. In this case, a mordant added afterwards may be the same as or different from the above mordant.

In the invention, the colorant-receiving layer coating liquid (coating liquid A) containing at least the fine particle (for example, vapor-phase method silica) and the water-soluble resin (e.g., polyvinyl alcohol) may be prepared, for example, in the following manner.

Specifically, the fine particle, such as vapor-phase method silica, and a dispersant are added to water (the content of the silica fine particle in water is 10 to 20 mass %) and dispersed under the condition of being rotated at speeds as high as, for example, 10000 rpm (preferably 5000 to 20000 rpm) for 20 minutes (preferably 10 to 30 minutes) using a high rotation wet colloid mill (for example, “Clearmix” manufactured by M Technique Co., Ltd.) An aqueous polyvinyl alcohol (PVA) solution is added (such that the mass of PVA is about ⅓ of that of the aforementioned vapor-phase silica) to the dispersion and dispersed under the same rotation conditions as above, whereby the coating liquid for the colorant-receiving layer can be prepared. It is preferable to adjust the solution to pH 9.2 using aqueous ammonia or to use a dispersant to prepare a stable coating liquid. The resulting coating liquid, which is in a uniform sol state, is applied to the support using the following application method and dried, whereby a porous colorant-receiving layer having a three-dimensional network structure can be formed.

As a dispersing machine used to obtain the water dispersion, various conventionally-known dispersing machines, such as a high rotation dispersing machine, medium stirring type dispersing machine (e.g., a ball mill and sand mill), ultraviolet dispersing machine, colloid mill dispersing machine and high pressure dispersing machine may be used. The medium stirring type dispersing machine, the colloid mill dispersing machine and the high pressure dispersing machine are preferable for dispersing the formed dimer fine particle in an efficient manner.

Also, as the solvent used in each step, water, an organic solvent or a mixture of these solvents may be used. Examples of the organic solvent which may be used for this application include alcohols such as methanol, ethanol, n-propanol, i-propanol and methoxypropanol, ketones such as acetone and methyl ethyl ketone, tetrahydrofuran, acetonitrile, ethyl acetate and toluene.

Also, as the aforementioned dispersant, a cationic polymer may be used. Examples of the cationic polymer are the same as those for the mordant. Also, as the dispersant, a silane coupling agent is preferably used.

The amount of the aforementioned dispersant to be added to the fine particle is preferably 0.1% to 30% and more preferably 1% to 10%.

The application of the colorant-receiving layer coating liquid may be carried out using a known coating method using an extrusion die coater, air doctor coater, blade coater, rod coater, knife coater, squeeze coater, reverse roll coater or bar coater.

At the same time when or after the colorant-receiving layer coating liquid (coating liquid A) is applied, the basic solution (coating liquid B) is added to the coated layer. The coating liquid B may be added before the applied coated layer shows the decreasing rate of drying. Namely, the inkjet recording sheet is appropriately produced by introducing the basic solution (coating liquid B) before the coated layer shows the decreasing rate of drying after the colorant-receiving layer coating liquid (coating liquid A) is applied. This coating liquid B may be made to contain a mordant.

Here, the aforementioned term “before the coated layer shows the decreasing rate of drying” generally indicates a period of several minutes from just after the colorant-receiving layer coating liquid is applied. During this period, a “constant drying rate” phenomenon that the content of a solvent (dispersion medium) in the coated layer decreases in proportion to time occurs. The time during which this “constant drying rate” is shown is described in, for example, Chemical Engineering Handbook (Maruzen, Oct. 25, 1980, pp.707-712).

As mentioned above, after the coating liquid A is applied, the coated layer is dried until it shows the decreasing rate of drying. This drying is carried out usually at 40 to 180° C. for 0.5 to 10 minutes (preferably 0.5 to 5 minutes). This drying time preferably falls in the above range in general though it, of course, differs depending on the amount to be applied.

Examples of a method of adding the coating liquid B before the aforementioned first coated layer shows the decreasing rate of drying include (1) a method in which the coating liquid B is further applied to the coated layer, (2) a method in which the coating liquid B is sprayed by, for example, a spraying method and (3) a method, in which the support having the coated layer formed thereon is dipped in the coating liquid B.

As a coating method for applying the coating liquid B in the aforementioned method (1), known coating methods using a curtain flow coater, extrusion die coater, air doctor coater, blade coater, rod coater, knife coater, squeeze coater, reverse roll coater or bar coater may be utilized. However, it is preferable to utilize a method in which the coater is not directly brought into contact with the first coated layer which has been already formed like the case of an extrusion die coater, curtain flow coater and bar coater.

After the coating liquid B is added, it is heated generally at 40 to 180° C. for 0.5 to 30 minutes to carry out drying and curing. Among these conditions, it is preferable to heat at 40 to 150° C. for 1 to 20 minutes.

Also, in the case of adding the aforementioned basic solution (coating liquid B) simultaneously when the colorant-receiving layer coating liquid (coating liquid A) is applied, the coating liquid A and the coating liquid B are applied (overlaying coating) to the support at the same time such that the coating liquid A is brought into contact with the support and then dried and cured whereby the colorant-receiving layer can be formed.

The aforementioned simultaneous application (overlaying coating) may be carried out using a coating method using an extrusion die coater or curtain flow coater. The coated layer formed after the simultaneous application is dried. The drying at this time is usually performed by heating the coated layer at 40 to 150° C. for 0.5 to 10 minutes and preferably at 40 to 100° C. for 0.5 to 5 minutes.

When the aforementioned simultaneous application (overlaying coating) is carried out using, for example, an extrusion die coater, two coating liquids discharged simultaneously are overlaid with each other in the vicinity of the discharge port of the extrusion die coater, namely, before these solutions are transferred to the support, and applied to the support in an overlaid manner in this state. The two layer coating liquids overlaid before being applied tend to enter into a crosslinking reaction at the boundary between the both solutions when transferring to the support. For this, the discharged two liquids are mixed so that the viscosity tend to increase in the vicinity of the discharged port of the extrusion die coater and there is the case where the coating operation is hindered. Therefore, when performing the simultaneous application as described above, a barrier layer liquid (intermediate layer liquid) is preferably interposed between the aforementioned both liquids simultaneously, when the coating liquid A and the coating liquid B are applied, to perform simultaneous application of a triple layer.

The barrier layer liquid may be selected without particular limitation. An aqueous solution containing trace amounts of a water-soluble resin and water may be given as an example. The aforementioned water-soluble resin is used in consideration of coatability for the purpose of fanctioning a thickener and the like. Examples of the water-soluble resin include cellulose type resins (e.g., hydroxypropylmethyl cellulose, methyl cellulose and hydroxyethylmethyl cellulose), polyvinylpyrrolidone and polymers such as gelatin. It is noted that the barrier layer liquid may contain the aforementioned mordant.

After the colorant-receiving layer is formed on the support, calendering treatment is performed by making the support pass between roll nips while applying heat and pressure, using a super calender or gloss calender, whereby the colorant-receiving layer can be improved in surface smoothness, glossiness, transparency and film strength. However, because the calendering treatment sometimes causes the aperture ratio to decrease (namely, because it sometimes causes a reduction in ink absorbancy), it is necessary that a condition are set under which the decrease of aperture ratio is reduced to carry out the treatment.

The temperature of the roll when performing the calendering treatment is preferably 30 to 150° C. and more preferably 40 to 100° C.

The line pressure between the rolls when performing the calendering treatment is preferably 50 to 400 kg/cm and more preferably 100 to 200 kg/cm.

The thickness of the aforementioned colorant-receiving layer must be determined in relation to the aperture ratio in the layer because it is required for the colorant-receiving layer to have an absorbing capacity sufficient to absorb all liquid droplets. In the case where, for example, the amount of ink is 8 nL/mm² and the aperture ratio is 60%, a film having a thickness of about 15 μm or more is required.

Taking this point into account, the thickness of the colorant-receiving layer is preferably 10 to 50 μm in the case of inkjet recording.

The pore diameter of the colorant-receiving layer is preferably 0.005 to 0.030 μm and more preferably 0.01 to 0.025 μm in terms of median diameter.

The aforementioned aperture ratio and pore median diameter may be measured using a mercury porosimeter (“Pore Sizer 9320-PC2” (Trademark), manufactured by Shimadzu Corporation).

Also, the colorant-receiving layer preferably has high transparency. As to the standard of the transparency, the haze value when the colorant-receiving layer is formed on a transparent film support is preferably 30% or less and more preferably 20% or less.

The above haze value may be measured using a haze meter (HGM-2DP, manufactured by Suga Test Instrument Co. Ltd.). A polymer fine particle dispersion may be added to the structural layers (e.g., the colorant-receiving layer and the back layer) of the inkjet recording sheet of the invention. This polymer fine particle dispersion is used with the intention of improving film qualities such as dimensional stability, prevention of curling, prevention of adhesion and prevention of cracking of the film. There are descriptions concerning the polymer fine particle dispersion in JP-A Nos. 62-245258, 62-1316648 and 62-110066. in this case, if a polymer fine particle dispersion having a low glass transition temperature (40° C. or less) is added to the aforementioned mordant-containing layer, cracking and curling of the layer can be prevented. Also, even the addition of a polymer fine particle dispersion having a high glass transition temperature to the back layer can prevent curling.

### EXAMPLES

The present invention will be explained in more detail by way of examples, which are not intended to be limiting of the invention. In the examples, all designations of “parts” and “% ” indicate “mass parts” and “mass percentage (mass %)”, respectively, unless otherwise noted and the designation of “polymerization degree” indicates “mass average polymerization degree”.

(Production of a Support)

Wood pulp consisting of 100 parts of LBKP was beaten down to a Canadian Freeness of 300 ml by using a double disk refiner, to which was then added 0.5 parts of epoxidated behenic acid amide, 1.0 parts of anionic polyacrylamide, 0.1 parts of polyamidopolyamineepichlorohydrin and 0.5 parts of cationic polyacrylamide, wherein each amount is expressed by absolute dry mass ratio to the pulp, to thereby produce using a Fourdrinier paper machine, base paper weighing 170 g/m².

In order to regulate the surface size of the above base paper, 0.04% of a fluorescent whitening agent (“Whitex BB”, manufactured by Sumitomo Chemical Co., Ltd.) was added to an aqueous 4% polyvinyl alcohol solution. The above base paper was impregnated with the resulting solution such that the amount of the solution was 0.5 g/m² converted into absolute dry mass and the solution was dried, followed by further performing calendering treatment to obtain substrate paper adjusted to a density of 1.05 g/cc.

The wire side (backface side) of the resulting substrate paper was processed by corona discharge treatment and then coated with high density polyethylene using a melt extruder such that the thickness of polyethylene was 19 μm to form a resin layer with a matted surface (hereinafter the resin layer side is referred to as a “backside”). The resin layer on this backside was further processed by corona discharge treatment. Then, a dispersion in which aluminum oxide (“Alumina Sol 100”, manufactured by Nissan Chemical Industries, Ltd.) and silicon dioxide (“Snowtex 0”, manufactured by Nissan Chemical Industries, Ltd.) were dispersed as antistatic agents in a mass ratio of 1:2 was applied to the resin layer such that the dry mass was 0.2 g/m².

Furthermore, the felt side (surface) on the side on which no resin layer was formed was processed by corona discharge treatment. Then, low density polyethylene containing 10% of anatase type titanium dioxide, a trace amount of ultramarine blue and 0.01% (based on polyethylene) of a fluorescent whitening agent was extruded at a MFR (melt flow rate) of 3.8 by using a melt extruder such that the thickness was 29 μm to form a highly glossy thermoplastic resin layer on the surface side of the substrate paper (hereinafter this highly glossy surface is referred to as a “front surface”), thereby making a support.

### Example 1

Preparation of a Colorant-Receiving Layer Coating Liquid A

(1) A vapor-phase method silica fine particle, (2) ion exchange water and (3) “PAS-M-1” in the composition described below were mixed and dispersed using high speed rotating type colloid mill (“Clearmix”, manufactured by M technique Co., Ltd.) at a rotation of 10000 rpm for 20 minutes. Then, a solution containing (4) polyvinyl alcohol, (5) boric acid, (6) polyoxyethylene lauryl ether and (7) ion exchange water described below was added to the above mixture, which was dispersed again at a rotation of 10000 rpm for 20 minutes to prepare a colorant-receiving layer coating liquid A.

The mass ratio (PB ratio: (1):(4)) of the silica fine particle to the water-soluble resin was 4.5:1 and the pH of the colorant-receiving layer coating liquid A was 3.5, showing that the resulting solution was acidic.

<Composition of the Colorant-Receiving Layer Coating Liquid A>

| | | |
|---|---|---|
| (1) Vapor-phase method silica fine particle (inorganic fine | 10 | parts |
| particle) (“Reolosil QS 30”, manufactured by Tokuyama, | | |
| average primary particle diameter: 7 nm) | | |
| (2) Ion exchange water | 51.7 | parts |
| (3) “PAS-M-1” (aqueous 60% solution) (dispersant, | 0.83 | parts |
| manufactured by Nittobo) | | |
| (4) Polyvinyl alcohol (water-soluble resin), 8% aqueous | 27.8 | parts |
| solution (“PVA 124”, manufactured by Kuraray Co., | | |
| Ltd., saponification value: 98.5%, degree of | | |
| polymerization: 2400) | | |
| (5) Boric acid (crosslinking agent) | 0.4 | parts |
| (6) Polyoxyethylene lauryl ether (surfactant) | 1.2 | parts |
| (“Emulgen 109P”, manufactured by Kao Corporation, | | |
| (aqueous 10% solution), HLB value: 13.6) | | |
| (7) Ion exchange water | 33.0 | parts |

Preparation of an Inkjet Recording Sheet

The front surface of the aforementioned support was processed by corona discharge treatment. Thereafter, the colorant-receiving layer coating liquid A obtained above was applied to the front surface of the support using an extrusion die coater such that the amount to be applied was 200 ml/m² (coating step). The coated layer was dried using a hot air drier at 80° C. (air-speed: 3 to 8 m/sec) until the solid concentration of the coated layer was 20%. This coated layer showed the decreasing rate of drying during this period. Just after the drying was finished, the resulting support was immersed in a mordant solution B having the composition described below for 30 minutes to stick 20 g/m² of the mordant solution to the coated layer (step of adding the mordant solution) and further the mordant solution B was dried at 80° C. for 10 minutes (drying step). By this treatment, the inkjet recording sheet (1) provided with the colorant-receiving layer having a dried film thickness of 32 μm according to the invention was produced.

<Composition of the Mordant Solution B>

| | | |
|---|---|---|
| (1) Boric acid (crosslinking agent) | 0.65 | parts |
| (2) Polyallylamine “PAA-10”, aqueous 10% solution | 25 | parts |
| (mordant, manufactured by Nittobo) | | |
| (3) Compound (a) described below | 2.5 | parts |
| (compound according to the invention) | | |
| (4) Ion exchange water | 59.7 | parts |
| (5) Ammonium chloride (surface pH regulator) | 0.8 | parts |
| (6) Polyoxyethylene lauryl ether (surfactant) | 10 | parts |
| (“Emulgen 109P”, manufactured by Kao Corporation, | | |
| aqueous 2% solution), HLB value: 13.6) | | |
| (7) Megafac “F1405”, aqueous 10% solution | 2.0 | parts |
| (fluorine type surfactant, manufactured by Dainippon | | |
| Ink and Chemicals, Incorporated) | | |

### Examples 2 to 7

Inkjet recording sheets (2) to (7) according to the invention were produced in the same manner as in Example 1, except that the compound (a) was changed to each of the following compounds (b) to (g) in the composition of the mordant solution B of Example 1.

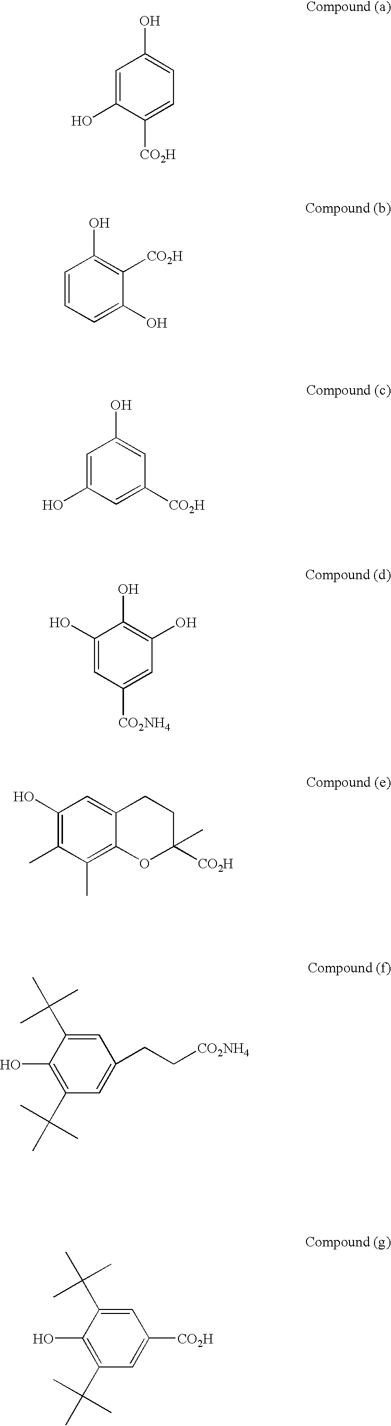

### Example 8

Inkjet recording sheet (8) according to the invention was produced in the same manner as in Example 1, except that 0.4 parts of the following additive (1) was further added to the composition of the mordant solution B of Example 1.

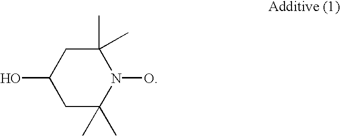

### Example 9

Inkjet recording sheet (9) according to the invention was produced in the same manner as in Example 1, except that one part of guanylthiourea (fastness improver) was further added to the composition of the mordant solution B of Example 1.

### Example 10

Inkjet recording sheet (10) according to the invention was produced in the same manner as in Example 1, except that 0.83 parts of “PAS-M-1” was altered to 0.6 parts of dimethyldiallylammonium chloride (“Shallol DC-902P”, manufactured by Dai-ichi Kogyo Seiyaku Co., Ltd., aqueous 50% solution) in the composition of the colorant-receiving layer coating liquid A of Example 1.

### Example 11

Inkjet recording sheet (11) according to the invention was produced in the same manner as in Example 1, except that 0.63 parts of basic aluminum chloride (Al₂(OH)₅Cl, “PAC #1000, manufactured by Taki Chemical Co., Ltd., aqueous 40% solution) was further added to the composition of the colorant-receiving layer coating liquid A of Example 1.

### Example 12

Inkjet recording sheet (12) according to the invention was produced in the same manner as in Example 1 except that 0.6 parts of zirconyl acetate (aqueous 30% solution) was further added in the composition of the colorant-receiving layer coating liquid A of Example 1.

### Example 13

Inkjet recording sheet (13) according to the invention was produced in the same manner as in Example 1, except that 0.2 parts of lanthanum nitrate was further added to the composition of the colorant-receiving layer coating liquid A of Example 1.

### Example 14

Inkjet recording sheet (14) according to the invention was produced in the same manner as in Example 1, except that 10.0 parts of the vapor-phase method silica fine particle was changed to 10.0 parts of an alumina fine particle (aluminum oxide, average primary particle diameter: 10 nm, manufactured by Japan Aerogyl) and the amount of boric acid was altered to 0.1 parts from 0.4 parts in the composition of the colorant-receiving layer coating liquid A of Example 1.

### Comparative Example 1

A comparative inkjet recording sheet (15) was produced in the same manner as in Example 1 except that 2.5 parts of the compound (a) was not used in the composition of the mordant solution B.

### Comparative Example 2

A comparative inkjet recording sheet (16) was produced in the same manner as in Example 1, except that 2.5 parts of the compound (a) was changed to 2.5 parts of HOCH₂CH₂SCH₂CH₂SCH₂CH₂OH in the composition of the mordant solution B.

### Comparative Example 3

A comparative inkjet recording sheet (17) was produced in the same manner as in Example 1, except that 25 parts of an aqueous 10% polyallylamine “PAA-10C” solution was changed to 25 parts of an aqueous 10% poly(N-(vinylbenzyl)triethylammonium chloride solution in the composition of the mordant solution B.

### Comparative Example 4

A comparative inkjet recording sheet (18) was produced in the same manner as in Example 1, except that 25 parts of an aqueous 10% polyallylamine “PAA-OC” solution was changed to 25 parts of an aqueous 10% diallylamine hydrochloride/sulfur dioxide copolymer (PAS-92, manufactured by Nittobo) solution in the composition of the mordant solution B.

(Test for Evaluation)

Each of the inkjet recording sheets (1) to (14) according to the invention and comparative inkjet recording sheets (15) to (18) was subjected to the following evaluation tests. The results of the evaluation are shown in Table 1.

(1) Ozone Resistance

Using an inkjet printer (“PM-900C”, manufactured by Seiko Epson), solid images of magenta and cyan were respectively printed on each inkjet recording sheet, which was then stored for 24 hours under an atmosphere containing ozone in a concentration of 2.5 ppm. Each concentration of magenta and cyan before and after the sheet was stored was measured by a reflection density meter (“Xrite 938, manufactured by Xrite) to calculate each residual rate of magenta and cyan densities.

Based on the calculated values, the case where the residual rate was 80% or more was rated as A, the case where the residual rate was 70 to 80% was rated as B, the case where the residual rate was 60% to 70% was rated as C and the case where the residual rate was less than 60% was rated as D to evaluate.

(2) Light Fastness

Using an inkjet printer (“PM-900C”, manufactured by Seiko Epson), solid images of magenta and cyan were respectively printed on each inkjet recording sheet. Thereafter, a cycle was repeated for 168 hours, wherein: the sheet was illuminated with a lamp of a Xenon Weather-Ometer Ci65A (Manufactured by ATLAS), through a filter, which cut ultraviolet light of 365 nm or less, for 3.8 hours, under conditions of a temperature of 25° C. and a relative humidity of 32%; and then allowed to stand with the lamp extinguished for one hour, under conditions of a temperature of 20° C. and a relative humidity of 91%.

The image density of each color before and after this test was measured using a reflection density meter (“Xrite 938”, manufactured by Xrite) to calculate the residual rate of each color density.

Based on the calculated value, the case where the residual rate was 90% or more was rated as A, the case where the residual rate was 80 to 90% was rated as B, the case where the residual rate was 70% to 80% was rated as C and the case where the residual rate was less than 70% was rated as D to evaluate.

(3) Bleeding Over Time

Using an inkjet printer (“PM-900C, manufactured by Seiko Epson), a lattice-like line pattern (line width: 0.28 mm) in which magenta ink and black ink are positioned adjacent to each other was printed on the inkjet recording sheet. The recording sheet was allowed to stand for 3 hours after printed and then stored for 3 days kept under a relative humidity of 90% by a thermohygrostat. Then, the line width of the black portion was measured to evaluate according to the following standard.

(Standard)

AA: Almost no occurrence of bleeding over time was found and the sheet was good. (Line width: 0.28 to 0.30 mm)

BB: Little bleeding over time was found, but was a practically acceptable level. (Line width: 0.31 to 0.35 mm)

CC: Significant bleeding over time was found and was a practically unacceptable level. (Line width: 0.35 mm)

TABLE 1

| | Ozone resistance | | Light fastness | | Bleeding |
|---|---|---|---|---|---|
| | Magenta | Cyan | Magenta | Cyan | with time |
| Example 1 | B | A | B | A | B |
| Example 2 | A | A | B | A | B |
| Example 3 | A | A | B | A | B |
| Example 4 | A | A | B | A | B |
| Example 5 | B | A | B | A | B |
| Example 6 | B | A | B | A | B |
| Example 7 | B | A | B | A | B |
| Example 8 | A | A | A | A | B |
| Example 9 | A | A | A | A | B |
| Example 10 | B | A | B | A | B |
| Example 11 | B | A | B | A | A |
| Example 12 | B | A | B | A | A |
| Example 13 | B | A | B | A | A |
| Example 14 | B | A | B | A | A |
| Comparative | D | C | A | A | B |
| Example 1 | | | | | |
| Comparative | D | C | A | A | B |
| Example 2 | | | | | |
| Comparative | C | B | A | A | C |
| Example 3 | | | | | |
| Comparative | C | B | A | A | C |
| Example 4 | | | | | |

It has been clarified from the results shown in Table 1 that the inkjet recording sheets (1) to (14) containing the phenolic compound and the organic mordant according to the invention have high ozone resistance since the residual rate of the density of the formed image is high even after these recording sheets are stored for a long period of time under an atmosphere containing high concentration of ozone. It has been also clarified that the residual rate of the density of the formed image is high even after the image is irradiated with xenon and even after the cycle test in which the sheet is allowed to stand under a high moisture condition, showing that these recording sheets are superior in light fastness, particularly in the light fastness of a developed magenta color and further these recording sheets are superior in resistance to bleeding over time. Also, in the case of the inkjet recording sheets (8) and (9) using a hindered amine type compound and a thiourea type compound together, inkjet recording sheets which are more superior in ozone resistance and light fastness could be obtained. Moreover, in the case of inkjet recording sheets (11) to (13) using a metal compound together, the bleeding of an image over time could be further increased.

On the contrary, in the case of the inkjet recording sheets (15) to (18) that use no combination of the phenolic compound and organic mordant according to the invention, the light fastness, the ozone resistance and the resistance to bleeding over time could not be satisfied at the same time.

According to the invention, an inkjet recording sheet which has particularly good ink-absorbancy, is free from bleeding over time and is improved in ozone resistance and light fastness can be provided.

What is claimed is:

1. An inkjet recording sheet comprising a support, and on the support, a colorant-receiving layer including:
a phenolic compound; and
at least one organic mordant selected from the group consisting of polyallylamine and derivatives thereof, and polyvinylamine and derivatives thereof.

2. The inkjet recording sheet of claim 1, wherein the phenolic compound comprises phenolic hydroxy groups and further comprises at least one substituent group selected from the group consisting of carboxyl groups, sulfo groups and salts thereof.

3. The inkjet recording sheet of claim 1, wherein the colorant-receiving layer comprises from 0.01 g/m² to 5 g/m² of the phenolic compound.

4. The inkjet recording sheet of claim 1, wherein a weight average molecular weight of the organic mordant is from 500 to 100,000.

5. The inkjet recording sheet of claim 1, wherein the colorant-receiving layer further comprises fine particles and a water-soluble resin.

6. The inkjet recording sheet of claim 5, wherein the fine particles comprise at least one of silica fine particles, colloidal silica, alumina fine particles and pseudo-boehmite.

7. The inkjet recording sheet of claim 5, wherein the fine particles comprise at least 50 mass % relative to a total mass of solid components of the colorant-receiving layer.

8. The inkjet recording sheet of claim 5, wherein the water-soluble resin comprises at least one water-soluble resin selected from a group consisting of polyvinyl alcohols and derivatives thereof, cellulose resins, resins having an ether bond, resins having a carbamoyl group and resins having a carboxyl group.

9. The inkjet recording sheet of claim 5, wherein the water-soluble resin comprises from 9 to 40 mass % relative to a total mass of solid components of the colorant-receiving layer.

10. The inkjet recording sheet of claim 5, wherein the fine particles in the colorant-receiving layer comprise a mass (x), the water-soluble resin in the colorant-receiving layer comprises a mass (y), and a mass ratio thereof (x/y) is from 1.5 to 10.

11. The inkjet recording sheet of claim 5, wherein the colorant-receiving layer further comprises a crosslinking agent, which can crosslink the water-soluble resin.

12. The inkjet recording sheet of claim 11, wherein the crosslinking agent comprises a crosslinking agent selected from a group consisting of boron compounds, aldehyde-based compounds, ketone-based compounds, active halogen compounds, active vinyl compounds, N-methylol compounds, melamine compounds, epoxy compounds, isocyanate-based compounds, aziridine-based compounds, carbodiimide-based compounds, ethylenimino-based compounds, halogenated carboxyaldehyde-based compounds, dioxane-based compounds, compounds that include a metal, polyamine compounds, hydrazide compounds, low-molecular weight compounds that include at least two oxazoline groups, polymers that include at least two oxazoline groups, multivalent acid anhydrides, acid chlorides, bissulfonate compounds and active ether compounds.

13. The inkjet recording sheet of claim 11, wherein an amount of the crosslinking agent used comprises from 1 to 50 mass % of an amount of the water-soluble resin used.

14. The inkjet recording sheet of claim 1, wherein the colorant-receiving layer further comprises a fastness improver.

15. The inkjet recording sheet of claim 1, wherein the colorant-receiving layer further comprises a surfactant and a high boiling-point organic solvent.

16. The inkjet recording sheet of claim 1, wherein a pH on a surface of the colorant-receiving layer is from 3 to 8.

17. The inkjet recording sheet of claim 1, wherein a thickness of the colorant-receiving layer is from 10 to 50 μm.

18. The inkjet recording sheet of claim 1, wherein the colorant-receiving layer further comprises pores which have a median diameter of from 0.005 to 0.030 μm.

19. The inkjet recording sheet of claim 1, wherein the support is transparent, and a haze value of the colorant-receiving layer formed thereon is no more than 30%.

20. The inkjet recording sheet of claim 1, wherein the colorant-receiving layer comprises a layer formed by a process including the steps of:
preparing a coating liquid containing at least fine particles and a water-soluble resin;
preparing a basic solution having a pH value of at least 8;
adding a crosslinking agent to at least one of the coating liquid and the basic solution;
applying the coating liquid to form a coated layer;
drying the coated layer;
crosslinking and curing the coated layer by adding the basic solution to the coated layer at a time that is at least one of (1) simultaneous with the step of applying the coating liquid to form the coated layer, and (2) before the coated layer exhibits a decreasing rate of drying during the step of drying the coated layer.
